(19) United States
(12) Patent Application Publication
(10) Pub. No.: US 2017/0092985 A1
(43) Pub. Date: Mar. 30, 2017

(54) SECONDARY BATTERY-USE ELECTROLYTIC SOLUTION, SECONDARY BATTERY, BATTERY PACK, ELECTRIC VEHICLE, ELECTRIC POWER STORAGE SYSTEM, ELECTRIC POWER TOOL, AND ELECTRONIC APPARATUS

(71) Applicant: SONY CORPORATION, TOKYO (JP)

(72) Inventors: SHUHEI SUGITA, KANAGAWA (JP); TADAHIKO KUBOTA, KANAGAWA (JP); TAKASHI MURAKAMI, KANAGAWA (JP)

(21) Appl. No.: 15/311,605

(22) PCT Filed: May 20, 2015
(86) PCT No.: PCT/JP2015/064441

§ 371 Date: Nov. 16, 2016

(30) Foreign Application Priority Data
Jun. 5, 2014 (JP) 2014-116975
Sep. 25, 2014 (JP) 2014-194769

(51) Int. Cl. H01M 10/0565; H01M 10/0567

(52) U.S. Cl. CPC H01M 10/0565; H01M 10/0567; H01M 2300/0025

(57) ABSTRACT

A secondary battery includes a cathode, an anode, and an electrolytic solution in which a polymer compound is dissolved.

### CROSS REFERENCE TO RELATED APPLICATIONS

This application is a U.S. National Phase of International Patent Application No. PCT/JP2015/064441 filed on May 20, 2015, which claims priority benefit of Japanese Patent Application No. JP 2014-116975 filed in the Japan Patent Office on Jun. 5, 2014 and also claims priority benefit of Japanese Patent Application No. JP 2014-194769 filed in the Japan Patent Office on Sep. 25, 2014. Each of the above-referenced applications is hereby incorporated herein by reference in its entirety.

### TECHNICAL FIELD

The present technology relates to an electrolytic solution used for a secondary battery, a secondary battery using the electrolytic solution, a battery pack, an electric vehicle, an electric power storage system, an electric power tool, and an electronic apparatus each of which uses the secondary battery.

### BACKGROUND ART

Various electronic apparatuses such as mobile phones and personal digital assistants (PDAs) have been widely used, and it has been demanded to further reduce size and weight of the electronic apparatuses and to achieve their longer lives. Accordingly, batteries, in particular, small and light-weight secondary batteries that have ability to achieve high energy density have been developed as power sources for the electronic apparatuses.

Applications of the secondary battery are not limited to the electronic apparatuses described above, and it has been also considered to apply the secondary battery to various other applications. Examples of such other applications may include: a battery pack attachably and detachably mounted on, for example, an electronic apparatus; an electric vehicle such as an electric automobile; an electric power storage system such as a home electric power server; and an electric power tool such as an electric drill.

There have been proposed secondary batteries that utilize various charge and discharge principles in order to obtain battery capacity. In particular, attention has been paid to a secondary battery that utilizes insertion and extraction of an electrode reactant or a secondary battery that utilizes precipitation and dissolution of an electrode reactant, which makes it possible to achieve higher energy density than other batteries such as a lead-acid battery and a nickel-cadmium battery.

The secondary battery includes a cathode, an anode, and an electrolytic solution. The composition of the electrolytic solution exerts a large influence on battery characteristics. Accordingly, various studies have been conducted on the composition of the electrolytic solution.

More specifically, in order to achieve superior cycle characteristics and other characteristics, an electrolytic solution contains a compound (having a molecular amount equal to or more than 500) having a reactive functional group and not having a polyethylene oxide skeleton (for example, refer to Patent Literature 1).

### CITATION LIST

### Patent Literature

Patent Literature 1: Japanese Unexamined Patent Application Publication No. 2014-013659

### SUMMARY

Electronic apparatuses and other apparatuses described above are more frequently used in association with higher performance and more multi-functionality thereof Accordingly, secondary batteries tend to be frequently charged and discharged. For this reason, there is still room for improvement in battery characteristics of the secondary batteries.

It is therefore desirable to provide a secondary battery-use electrolytic solution, a secondary battery, a battery pack, an electric vehicle, an electric power storage system, an electric power tool, an electronic apparatus each of which makes it possible to achieve superior battery characteristics.

A secondary battery-use electrolytic solution according to an embodiment of the present technology includes a polymer compound that is dissolved in the secondary batter-use electrolytic solution. A secondary battery according to an embodiment of the present technology includes a cathode, an anode, and an electrolytic solution, and the electrolytic solution has a similar structure to that of the foregoing secondary battery-use electrolytic solution according to the embodiment of the present technology. A battery pack, an electric vehicle, an electric power storage system, an electric power tool, and an electronic apparatus according to embodiments of the present technology each include a secondary battery, and the secondary battery has a similar configuration to that of the secondary battery according to the foregoing embodiment of the present technology.

Herein, the “polymer compound is dissolved” means that the electrolytic solution containing the polymer compound is a homogeneous mixture in a liquid state, and therefore, the polymer compound in the liquid state is uniformly dispersed in the electrolytic solution. Accordingly, in the electrolytic solution in which the polymer compound is dissolved, even though the electrolytic solution is left to stand, a precipitate is not present, and even though the electrolytic solution is irradiated with light, the Tyndall effect (light scattering) does not occur.

According to the secondary battery-use electrolytic solution or the secondary battery of the embodiment of the present technology, the polymer compound is dissolved in the electrolytic solution, which makes it possible to achieve superior battery characteristics. Moreover, in the battery pack, the electric vehicle, the electric power storage system, the electric power tool, or the electronic apparatus of the embodiment of the present technology, similar effects are achievable. Note that effects described here are non-limiting. Effects achieved by the present technology may be one or more of effects described in the present technology.

### BRIEF DESCRIPTION OF DRAWINGS

FIG. 1 is a cross-sectional view of a configuration of a secondary battery (cylindrical type) according to an embodiment of the present technology.

FIG. 2 is a cross-sectional view of part of a spirally wound electrode body illustrated in FIG. 1.

FIG. 3 is a cross-sectional view of another configuration of part of the spirally wound electrode body illustrated in FIG. 1.

FIG. 4 is a perspective view of a configuration of another secondary battery (laminated film type) according to the embodiment of the present technology.

FIG. 5 is a cross-sectional view taken along a line V-V of a spirally wound electrode body illustrated in FIG. 4.

FIG. 6 is a cross-sectional view of a configuration of part of the spirally wound electrode body illustrated in FIG. 5.

FIG. 7 is a cross-sectional view of another configuration of part of the spirally wound electrode body illustrated in FIG. 5.

FIG. 8 is a perspective view of a configuration of an application example (a battery pack: single battery) of the secondary battery.

FIG. 9 is a block diagram illustrating a configuration of the battery back illustrated in FIG. 8.

FIG. 10 is a block diagram illustrating a configuration of an application example (a battery back: assembled battery) of the secondary battery.

FIG. 11 is a block diagram illustrating a configuration of an application example (an electric vehicle) of the secondary battery.

FIG. 12 is a block diagram illustrating a configuration of an application example (an electric power storage system) of the secondary battery.

FIG. 13 is a block diagram illustrating a configuration of an application example (an electric power tool) of the secondary battery.

### EMBODIMENTS FOR CARRYING OUT THE INVENTION

In the following, some embodiments of the present technology are described in detail with reference to the drawings. It is to be noted that description is given in the following order.

1. Secondary Battery-use Electrolytic Solution and Secondary Battery
1-1. Lithium-ion Secondary Battery (Cylindrical Type)
1-2. Lithium-ion Secondary Battery (Laminated Film Type)
1-3. Lithium Metal Secondary Battery

2. Applications of Secondary Battery
2-1. Battery Pack (Single Battery)
2-2. Battery Pack (Assembled Battery)
2-3. Electric Vehicle
2-4. Electric Power Storage System
2-5. Electric Power Tool

<1. Secondary Battery-Use Electrolytic Solution and Secondary Battery>

First, description is given of a secondary battery-use electrolytic solution and a secondary battery using the secondary battery-use electrolytic solution of embodiments of the present technology.

<1-1. Lithium-Ion Secondary Battery (Cylindrical Type)>

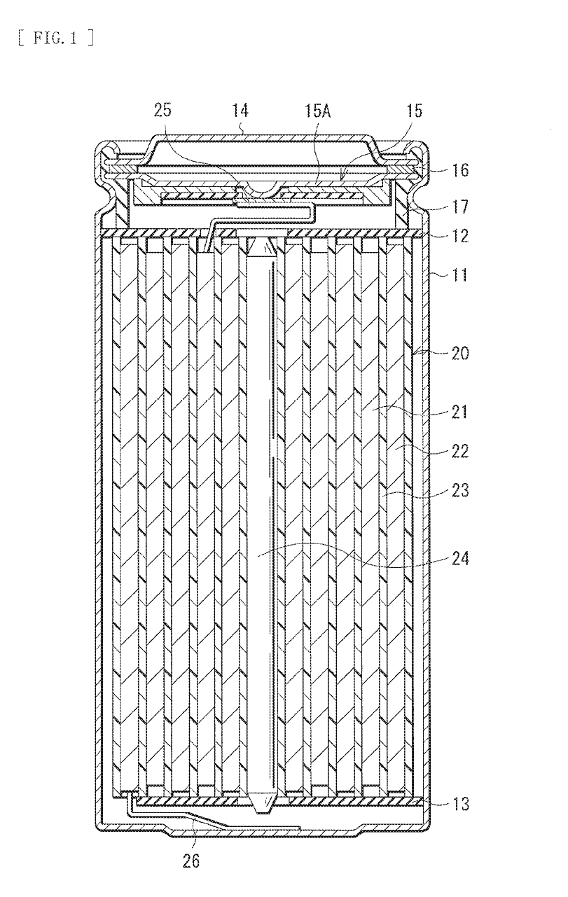

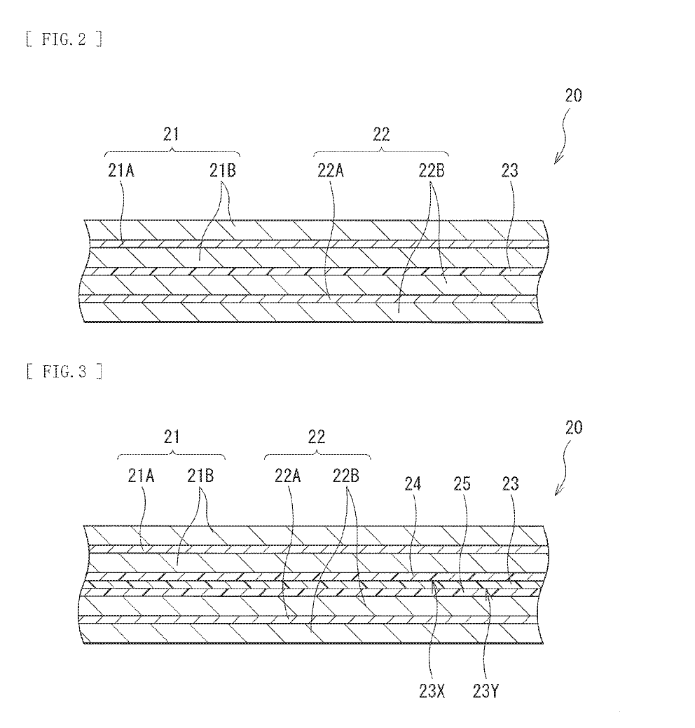

FIG. 1 illustrates a cross-sectional configuration of a secondary battery. FIG. 2 illustrates a cross-sectional configuration of part of a spirally wound electrode body 20 illustrated in FIG. 1. FIG. 3 illustrates another cross-sectional configuration of part of the spirally wound electrode body 20.

The secondary battery described here may be, for example, a lithium secondary battery (a lithium-ion secondary battery) in which a capacity of an anode 22 is obtained by insertion and extraction of lithium as an electrode reactant.

[Whole Configuration of Secondary Battery]

The secondary battery has a so-called cylindrical type battery configuration. The secondary battery may contain, for example, a pair of insulating plates 12 and 13 and the spirally wound electrode body 20 inside a battery can 11 having a substantially hollow cylindrical shape, as illustrated in FIG. 1. The spirally wound electrode body 20 may be formed, for example, by stacking a cathode 21 and an anode 22 with a separator 23 in between, and thereafter, spirally winding the cathode 21, the anode 22, and the separator 23. The spirally wound electrode body 20 is impregnated with an electrolytic solution (secondary battery-use electrolytic solution) that is a liquid electrolyte.

The battery can 11 may have, for example, a hollow structure in which one end of the battery can 11 is closed and the other end of the battery can 11 is open. The battery can 11 may be made of one or more of, for example, iron (Fe), aluminum (Al), and an alloy thereof. A surface of the battery can 11 may be plated with, for example, nickel. The pair of insulating plates 12 and 13 is so disposed as to sandwich the spirally wound electrode body 20 in between and extend perpendicularly to a spirally wound periphery surface of the spirally wound electrode body 20.

At the open end of the battery can 11, a battery cover 14, a safety valve mechanism 15, and a positive temperature coefficient device (PTC device) 16 are swaged with a gasket 17, by which the battery can 11 is hermetically sealed. The battery cover 14 may be made of, for example, a similar material to the material of the battery can 11. Each of the safety valve mechanism 15 and the PTC device 16 is provided on the inner side of the battery cover 14, and the safety valve mechanism 15 is electrically coupled to the battery cover 14 via the PTC device 16. In the safety valve mechanism 15, when an internal pressure of the battery can 11 reaches a certain level or higher as a result of, for example, internal short circuit or heating from outside, a disk plate 15A inverts. This cuts electric connection between the battery cover 14 and the spirally wound electrode body 20. In order to prevent abnormal heat generation resulting from a large current, resistance of the PTC device 16 increases as a temperature rises. The gasket 17 may be made of, for example, an insulating material. A surface of the gasket 17 may be coated with asphalt.

For example, a center pin 24 may be inserted in the center of the spirally wound electrode body 20. However, the center pin 24 may not be inserted in the center of the spirally wound electrode body 20. A cathode lead 25 is attached to the cathode 21, and an anode lead 26 is attached to the anode 22. The cathode lead 25 may be made of, for example, a conductive material such as aluminum. For example, the cathode lead 25 may be attached to the safety valve mechanism 15, and may be electrically coupled to the battery cover 14. The anode lead 26 may be made of, for example, a conductive material such as nickel. For example, the anode lead 26 may be attached to the battery can 11, and may be electrically coupled to the battery can 11.

[Cathode]

The cathode 21 includes a cathode current collector 21A and a cathode active material layer 21B provided on both surfaces of the cathode current collector 21A. Alternatively, the cathode active material layer 21B may be provided only on a single surface of the cathode current collector 21A.

The cathode current collector 21A may contain one or more of conductive materials. The kind of the conductive material is not particularly limited, but may be, for example, a metal material such as aluminum (Al), nickel (Ni), and stainless steel. The cathode current collector 21A may be configured of a single layer, or may be configured of multiple layers.

The cathode active material layer 21B may contain, as a cathode active material, one or more of cathode materials that have ability to insert and extract lithium. It is to be noted that the cathode active material layer 21B may further contain one or more of other materials such as a cathode binder and a cathode conductor.

The cathode material may be preferably a lithium-containing compound. More specifically, the cathode material may be preferably one or both of a lithium-containing composite oxide and a lithium-containing phosphate compound, which makes it possible to achieve high energy density.

The lithium-containing composite oxide is an oxide that contains lithium and one or more elements that exclude lithium (hereinafter, referred to as “other elements”) as constituent elements, and may have, for example, a crystal structure such as a layered rock-salt crystal structure and a spinel crystal structure. The lithium-containing phosphate compound refers to a phosphate compound that contains lithium and one or more of the other elements as constituent elements, and may have, for example, a crystal structure such as an olivine crystal structure.

The kinds of the other elements are not particularly limited, as long as the other elements are one or more of any elements. In particular, the other elements may be preferably one or more of elements that belongs to Groups 2 to 15 in the long form of the periodic table of the elements. More specifically, the other elements may more preferably include one or more metal elements of nickel (Ni), cobalt (Co), manganese (Mn), and iron (Fe), which make it possible to obtain a high voltage.

In particular, the lithium-containing composite oxide having the layered rock-salt crystal structure may be preferably one or more of compounds represented by respective following formulas (11) to (13).

LiₐMn_{(1-b-c)}Ni_{b}M11_{c}O_{(2-d)}Fe (11)
where M11 is one or more of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W), “a” to “e” satisfy 0.8≦a≦1.2, 0<b<0.5, 0≦c≦0.5, (b+c)<1, −0.1≦d≦0.2, and 0≦e≦0.1, it is to be noted that the composition of lithium varies depending on charge and discharge states, and “a” is a value in a completely-discharged state.

LiₐNi_{(1-b)}M12_{b}O_{(2-c)}F_{d} (12)

where M12 is one or more of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W), “a” to “d” satisfy 0.8≦a≦1.2, 0.005≦b≦0.5, −0.1≦c≦0.2, and 0≦d≦0.1, it is to be noted that the composition of lithium varies depending on charge and discharge states, and “a” is a value in a completely-discharged state.

LiₐCo_{(1-b)}M13_{b}O_{(2-c)}F_{d} (13)

where M13 is one or more of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W), “a” to “d” satisfy 0.8≦a≦1.2, 0≦b<0.5, −0.1≦c≦0.2, and 0≦d≦0.1, it is to be noted that the composition of lithium varies depending on charge and discharge states, and “a” is a value in a completely-discharged state.

Non-limiting specific examples of the lithium-containing composite oxide having the layered rock-salt crystal structure may include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂.

It is to be noted that in a case in which the lithium-containing composite oxide having the layered rock-salt crystal structure contains nickel, cobalt, manganese, and aluminum as constituent elements, an atomic ratio of nickel may be preferably 50 at % or more, which makes it possible to achieve high energy density.

The lithium-containing composite oxide having the spinel crystal structure may be, for example, a compound represented by the following formula (14).

LiₐMn_{(2-b)}M14_{b}O_{c}F_{d} (14)

where M14 is one or more of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W), “a” to “d” satisfy 0.9≦a≦1.1, 0≦b≦0.6, 3.7≦c≦4.1, and 0≦d≦0.1, it is to be noted that the composition of lithium varies depending on charge and discharge states, and “a” is a value in a completely-discharged state.

Non-limiting specific examples of the lithium-containing composite oxide having the spinel crystal structure may include LiMn₂O₄.

The lithium-containing phosphate compound having the olivine crystal structure may be, for example, a compound represented by the following formula (15).

LiₐM15PO₄ (15)

where M15 is one or more of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr), “a” satisfies 0.9≦a≦1.1, it is to be noted that the composition of lithium varies depending on charge and discharge states, and “a” is a value in a completely-discharged state.

Non-limiting specific examples of the lithium-containing phosphate compound having the olivine crystal structure may include LiFePO₄, LiMnPO₄, LiFe_{0.5}Mn_{0.5}PO₄, and LiFe_{0.3}Mn_{0.7}PO₄.

It is to be noted that the lithium-containing composite oxide may be a compound represented by the following formula (16).

(Li₂MnO₃)ₓ(LiMnO₂)₁₋ₓ (16)

where “x” satisfies 0≦x≦1, it is to be noted that the composition of lithium varies depending on charge and discharge states, and “x” has a value in a completely-discharged state.

In addition, the cathode material may be, for example, one or more of an oxide, a disulfide, a chalcogenide, and a conductive polymer. Non-limiting examples of the oxide may include titanium oxide, vanadium oxide, and manganese dioxide. Non-limiting examples of the disulfide may include titanium disulfide and molybdenum sulfide. Non-limiting examples of the chalcogenide may include niobium selenide. Non-limiting examples of the conductive polymer may include sulfur, polyaniline, and polythiophene. However, the cathode material may be a material other than the foregoing materials.

The cathode binder may contain, for example, one or more of synthetic rubbers and polymer materials. Non-limiting examples of the synthetic rubbers may include a styrene-butadiene-based rubber, a fluorine-based rubber, and ethylene propylene diene. Non-limiting examples of the polymer materials may include polyvinylidene fluoride and polyimide.

The cathode conductor may contain, for example, one or more of carbon materials. Non-limiting examples of the carbon materials may include graphite, carbon black, acetylene black, and Ketjen black. It is to be noted that the cathode conductor may be a metal material, a conductive polymer, or any other material, as long as the cathode conductor is a material having conductivity.

[Anode]

The anode 22 includes an anode current collector 22A and an anode active material layer 22B provided on both surfaces of the anode current collector 22A. Alternatively, the anode active material layer 22B may be provided only on a single surface of the anode current collector 22A.

The anode current collector 22A may contain, for example, one or more of conductive materials. The kind of the conductive material is not particularly limited, but may be, for example, a metal material such as copper (Cu), aluminum (Al), nickel (Ni), and stainless steel. The anode current collector 22A may be configured of a single layer, or may be configured of multiple layers.

A surface of the anode current collector 22A may be preferably roughened. This makes it possible to improve adhesibility of the anode active material layer 22B with respect to the anode current collector 22A by a so-called anchor effect. In this case, it may be only necessary to roughen the surface of the anode current collector 22A at least in a region facing the anode active material layer 22B. Non-limiting examples of a roughening method may include a method of forming fine particles with use of electrolytic treatment. Through the electrolytic treatment, the fine particles are formed on the surface of the anode current collector 22A in an electrolytic bath by an electrolytic method to make the surface of the anode current collector 22A rough. A copper foil fabricated by the electrolytic method is generally called “electrolytic copper foil.”

The anode active material layer 22B contains, as an anode active material, one or more of anode materials that have ability to insert and extract lithium. The anode active material layer 22B may further contain one or more of other materials such as an anode binder and an anode conductor, in addition to the anode active material.

In order to prevent lithium from being unintentionally precipitated on the anode 22 in the middle of charge, chargeable capacity of the anode material may be preferably larger than discharge capacity of the cathode 21. In other words, electrochemical equivalent of the anode material that has ability to insert and extract lithium may be preferably larger than electrochemical equivalent of the cathode 21.

The anode material may be, for example, one or more of carbon materials. The carbon material causes an extremely small change in a crystal structure thereof during insertion and extraction of lithium, which stably achieves high energy density. Further, the carbon material also serves as an anode conductor, which improves conductivity of the anode active material layer 22B.

Non-limiting examples of the carbon material may include graphitizable carbon, nongraphitizable carbon, and graphite. It is to be noted that a spacing of (002) plane in the nongraphitizable carbon may be preferably 0.37 nm or larger, and a spacing of (002) plane in the graphite may be preferably 0.34 nm or smaller. More specific examples of the carbon material may include pyrolytic carbons, cokes, glassy carbon fibers, an organic polymer compound fired body, activated carbon, and carbon blacks. Non-limiting examples of the cokes may include pitch coke, needle coke, and petroleum coke. The organic polymer compound fired body is a material that is obtained by firing (carbonizing) a polymer compound such as phenol resin and furan resin at an appropriate temperature. Other than the materials mentioned above, the carbon material may be low crystalline carbon that is subjected to heat treatment at a temperature of about 1000° C. or lower, or may be amorphous carbon. It is to be noted that a shape of the carbon material may be any of a fibrous shape, a spherical shape, a granular shape, and a scale-like shape.

Moreover, the anode material may be, for example, a material (a metal-based material) that contains one or more of metal elements and metalloid elements as constituent elements. This makes it possible to achieve high energy density.

The metal-based material may be any of a simple substance, an alloy, or a compound, may be two or more thereof, or may have one or more phases thereof at least in part. It is to be noted that the “alloy” also encompasses a material that contains one or more metal elements and one or more metalloid elements, in addition to a material that is configured of two or more metal elements. Further, the “alloy” may contain a nonmetallic element. Non-limiting examples of a structure of the metal-based material may include a solid solution, a eutectic crystal (a eutectic mixture), an intermetallic compound, and a structure in which two or more thereof coexist.

The metal elements and the metalloid elements mentioned above may be, for example, one or more of metal elements and metalloid elements that are able to form an alloy with lithium. Non-limiting specific examples thereof may include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc, hafnium (Hf), zirconium, yttrium (Y), palladium (Pd), and platinum (Pt).

In particular, silicon, tin, or both may be preferable. Silicon and tin have superior ability to insert and extract lithium, and achieve remarkably high energy density accordingly.

A material that contains silicon, tin, or both as constituent elements may be any of a simple substance, an alloy, and a compound of silicon, may be any of a simple substance, an alloy, and a compound of tin, may be two or more thereof, or may be a material that has one or more phases thereof at least in part. Note that the “simple substance” described here merely refers to a simple substance in a general sense (in which a small amount of impurity may be contained), and does not necessarily refer to a simple substance having a purity of 100%.

The alloy of silicon may contain, for example, one or more of elements such as tin, nickel, copper, iron, cobalt, manganese, zinc, indium, silver, titanium, germanium, bismuth, antimony, and chromium, as constituent elements other than silicon. The compound of silicon may contain, for example, one or more of elements such as carbon and oxygen as constituent elements other than silicon. It is to be noted that the compound of silicon may contain, for example, one or more of the elements described related to the alloy of silicon, as constituent elements other than silicon.

Non-limiting specific examples of the alloy of silicon and the compound of silicon may include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO. Note that “v” in SiOᵥ may be in a range of 0.2<v<1.4.

The alloy of tin may contain, for example, one or more of elements such as silicon, nickel, copper, iron, cobalt, manganese, zinc, indium, silver, titanium, germanium, bismuth, antimony, and chromium, as constituent elements other than tin. The compound of tin may contain, for example, one or more of elements such as carbon and oxygen, as constituent elements other than tin. It is to be noted that the compound of tin may contain, for example, one or more of the elements described related to the alloy of tin, as constituent elements other than tin.

Non-limiting specific examples of the alloy of tin and the compound of tin may include SnO_{w} (0<w≦2), SnSiO₃, LiSnO, and Mg₂Sn.

In particular, the material that contains tin (a first constituent element) as a constituent element may be preferably, for example, a material that contains, together with tin, a second constituent element and a third constituent element. The second constituent element may be, for example, one or more of elements such as cobalt, iron, magnesium, titanium, vanadium, chromium, manganese, nickel, copper, zinc, gallium, zirconium, niobium, molybdenum, silver, indium, cesium (Ce), hafnium (Hf), tantalum, tungsten, bismuth, and silicon. The third constituent element may be, for example, one or more of elements such as boron, carbon, aluminum, and phosphorus (P). The Sn-containing material containing the second constituent element and the third constituent element makes it possible to achieve, for example, high battery capacity and superior cycle characteristics.

In particular, a material (a SnCoC-containing material) that contains tin, cobalt, and carbon as constituent elements may be preferable. In the SnCoC-containing material, for example, a content of carbon may be from 9.9 mass % to 29.7 mass % both inclusive, and a ratio of contents of tin and cobalt (Co/(Sn+Co)) may be from 20 mass % to 70 mass % both inclusive. This makes it possible to achieve high energy density.

The SnCoC-containing material may preferably have a phase that contains tin, cobalt, and carbon. Such a phase may be preferably low crystalline or amorphous. This phase is a reaction phase that is able to react with lithium. Hence, existence of the reaction phase results in achievement of superior characteristics. A half width (a diffraction angle 2θ) of a diffraction peak obtained by X-ray diffraction of this reaction phase may be preferably 1° or larger in a case in which a CuKα ray is used as a specific X-ray, and an insertion rate is 1°/min. This makes it possible to insert and extract lithium more smoothly, and to decrease reactivity with the electrolytic solution. It is to be noted that, in some cases, the SnCoC-containing material may include a phase that contains simple substances of the respective constituent elements or part thereof in addition to the low-crystalline phase or the amorphous phase.

Comparison between X-ray diffraction charts before and after an electrochemical reaction with lithium makes it possible to easily determine whether the diffraction peak obtained by the X-ray diffraction corresponds to the reaction phase that is able to react with lithium. For example, if a position of the diffraction peak after the electrochemical reaction with lithium is changed from the position of the diffraction peak before the electrochemical reaction with lithium, the obtained diffraction peak corresponds to the reaction phase that is able to react with lithium. In this case, for example, the diffraction peak of the low-crystalline reaction phase or the amorphous reaction phase is seen in a range of 2θ that is from 20° to 50° both inclusive. Such a reaction phase may include, for example, the respective constituent elements mentioned above, and it may be considered that such a reaction phase has become low crystalline or amorphous mainly because of existence of carbon.

In the SnCoC-containing material, part or all of carbon that is the constituent element thereof may be preferably bound to a metal element or a metalloid element that is another constituent element thereof. Binding part or all of carbon suppresses cohesion or crystallization of, for example, tin. It is possible to confirm a binding state of the elements, for example, by X-ray photoelectron spectroscopy (XPS). In a commercially-available apparatus, for example, an Al-Kα ray or a Mg-Kα ray may be used as a soft X-ray. In a case in which part or all of carbon is bound to a metal element, a metalloid element, or another element, a peak of a synthetic wave of 1 s orbit of carbon (C1s) appears in a region lower than 284.5 eV. It is to be noted that energy calibration is so made that a peak of 4f orbit of a gold atom (Au4f) is obtained at 84.0 eV. In this case, in general, surface contamination carbon exists on the material surface. Hence, a peak of C1s of the surface contamination carbon is regarded to be at 284.8 eV, and this peak is used as energy standard. In XPS measurement, a waveform of the peak of C1s is obtained as a form that includes the peak of the surface contamination carbon and the peak of the carbon in the SnCoC-containing material. The two peaks may be therefore separated from each other, for example, by analysis with use of commercially-available software. In the analysis of the waveform, a position of the main peak that exists on the lowest bound energy side is regarded as the energy standard (284.8 eV).

The SnCoC-containing material is not limited to a material (SnCoC) that contains only tin, cobalt, and carbon as constituent elements. The SnCoC-containing material may further contain, for example, one or more of elements such as silicon, iron, nickel, chromium, indium, niobium, germanium, titanium, molybdenum, aluminum, phosphorus, gallium, and bismuth, as constituent elements, in addition to tin, cobalt, and carbon.

Other than the SnCoC-containing material, a material (a SnCoFeC-containing material) that contains tin, cobalt, iron, and carbon as constituent elements may be also preferable. Any composition of the SnCoFeC-containing material may be adopted. To give an example, in a case in which a content of iron is set smaller, a content of carbon may be from 9.9 mass % to 29.7 mass % both inclusive, a content of iron may be from 0.3 mass % to 5.9 mass % both inclusive, and a ratio of contents of tin and cobalt (Co/(Sn+Co)) may be from 30 mass % to 70 mass % both inclusive. Alternatively, in a case in which the content of iron is set larger, the content of carbon may be from 11.9 mass % to 29.7 mass % both inclusive, the ratio of contents of tin, cobalt, and iron ((Co+Fe)/(Sn+Co+Fe)) may be from 26.4 mass % to 48.5 mass % both inclusive, and the ratio of contents of cobalt and iron (Co/(Co+Fe)) may be from 9.9 mass % to 79.5 mass % both inclusive. Such composition ranges allow for achievement of high energy density. It is to be noted that physical characteristics (such as a half width) of the SnCoFeC-containing material are similar to physical characteristics of the foregoing SnCoC-containing material.

Other than the materials mentioned above, the anode material may be, for example, one or more of a metal oxide, and a polymer compound. Non-limiting examples of the metal oxide may include iron oxide, ruthenium oxide, and molybdenum oxide. Non-limiting examples of the polymer compound may include polyacetylene, polyaniline, and polypyrrole.

In particular, the anode material may preferably contain both the carbon material and the metal-based material for the following reason.

The metal-based material, in particular, the material containing one or both of silicon and tin as constituent elements has a concern that such a material is easily and radically expanded or contracted when the secondary battery is charged or discharged, whereas such a material has an advantage of high theoretical capacity. In contrast, the carbon material has an advantage that the carbon material is less prone to be expanded or contracted when the secondary battery is charged or discharged, whereas the carbon material has a concern of low theoretical capacity. Hence, using both the carbon material and the metal-based material makes it possible to suppress swelling and contraction during charge and discharge of the secondary battery while achieving high theoretical capacity (in other words, high battery capacity).

The anode active material layer 22B may be formed by, for example, one or more of a coating method, a vapor-phase method, a liquid-phase method, a spraying method, and a firing method (sintering method). The coating method may be, for example, a method in which, after a particulate (powder) anode active material is mixed with, for example, an anode binder, the mixture is dispersed in a solvent such as an organic solvent, and the resultant is applied onto the anode current collector 22A. Non-limiting examples of the vapor-phase method may include a physical deposition method and a chemical deposition method. More specifically, non-limiting examples thereof may include a vacuum evaporation method, a sputtering method, an ion plating method, a laser ablation method, a thermal chemical vapor deposition method, a chemical vapor deposition (CVD) method, and a plasma chemical vapor deposition method. Non-limiting examples of the liquid-phase method may include an electrolytic plating method and an electroless plating method. The spraying method is a method in which an anode active material in a fused state or a semi-fused state is sprayed to the anode current collector 22A. The firing method may be, for example, a method in which, after the mixture dispersed in, for example, the solvent is applied onto the anode current collector 22A by the coating method, the resultant is subjected to heat treatment at a temperature higher than a melting point of, for example, the anode binder. For example, one or more of an atmosphere firing method, a reactive firing method, a hot press firing method, and other firing methods may be employed as the firing method.

In the secondary battery, in order to prevent lithium metal from being unintentionally precipitated on the anode 22 in the middle of charge, electrochemical equivalent of the anode material that has ability to insert and extract lithium is larger than electrochemical equivalent of the cathode, as described above. Moreover, in a case in which an open circuit voltage (that is, a battery voltage) in a completely-charged state is 4.25 V or higher, an extraction amount of lithium per unit mass is larger than that in a case in which the open circuit voltage is 4.2 V, even if the same cathode active material is used. Hence, amounts of the cathode active material and the anode active material are adjusted in accordance therewith. As a result, high energy density is achieved.

[Separator]

For example, the separator 23 may be disposed between the cathode 21 and the anode 22 as illustrated in FIG. 2. The separator 23 separates the cathode 21 from the anode 22, and passes lithium ions therethrough while preventing current short circuit that results from contact between the cathode 21 and the anode 22.

The separator 23 may be, for example, one or more of porous films such as porous films of a synthetic resin and ceramics. The separator 23 may be a laminated film in which two or more porous films are laminated. Non-limiting examples of the synthetic resin may include polytetrafluoroethylene, polypropylene, and polyethylene.

[Polymer Compound Layer]

In the secondary battery, for example, a polymer compound layer 24 may be disposed between the cathode 21 and the separator 23, and a polymer compound layer 25 may be disposed between the anode 22 and the separator 23, as illustrated in FIG. 3. The polymer compound layers 24 and 25 allow for an improvement in adhesibility of the separator 23 with respect to the cathode 21 and the anode 22, thereby suppressing deformation of the spirally wound electrode body 20. This makes it possible to suppress decomposition reaction of the electrolytic solution and leakage of the electrolytic solution with which the separator 23 is impregnated. Accordingly, even if the secondary battery is repeatedly charged and discharged, resistance of the secondary battery is less prone to increase, and the secondary battery is less prone to be swollen.

Alternatively, only the polymer compound layer 24 may be disposed, or only the polymer compound layer 25 may be disposed. In the former case, adhesibility of the separator 23 with respect to the cathode 21 is improved, and in the latter case, adhesibility of the separator 23 with respect to the anode 22 is improved.

Each of the polymer compound layers 24 and 25 may contain, for example, one or more of fluorine-containing polymer compounds. The fluorine-containing polymer compound is a polymer compound containing one or more fluorines (F) as a constituent element, and, for example, the kind of a carbon skeleton included in the fluorine-containing polymer compound is not particularly limited.

The fluorine-containing polymer compound may be, for example, a polymer containing vinylidene fluoride as a component. Non-limiting specific examples of the fluorine-containing polymer compound may include a homopolymer, a copolymer, and a multicomponent copolymer. The homopolymer is polyvinylidene fluoride. Non-limiting examples of the copolymer may include a binary copolymer containing vinylidene fluoride and hexafluoropropylene as monomeric components. Non-limiting multicomponent copolymer may include a ternary copolymer containing vinylidene fluoride, hexafluoropropylene, and chlorotrifluoroethylene as monomeric components. Such polymer compounds are superior in physical strength and are electrochemically stable.

It is to be noted that each of the polymer compound layers 24 and 25 may contain one or more of non-fluorine-containing polymer compounds together with the fluorine-containing polymer compound. The non-fluorine-containing polymer compound is a polymer compound not containing fluorine as a constituent element.

Herein, as long as the polymer compound layer 24 is interposed between the cathode 21 and the separator 23, the polymer compound layer 24 may be provided on a surface of the cathode 21 or a surface of the separator 23. Providing the polymer compound layer 24 on the surface of the cathode 21 means that the polymer compound layer 24 is formed on the surface of the cathode 21, and the polymer compound layer 24 is therefore fixed on the surface of the cathode 21. Likewise, providing the polymer compound layer 24 on the surface of the separator 23 means that the polymer compound layer 24 is formed on the surface of the separator 23, and the polymer compound layer 24 is therefore fixed on the surface of the separator 23.

In particular, the polymer compound layer 24 may be preferably provided on the surface of the separator 23. The polymer compound layer 24 and the separator 23 are integrated, thereby improving, for example, handleability of the separator 23.

The above-described details of a position where the polymer compound layer 24 is formed may be similarly applied to a position where the polymer compound layer 25 is formed. More specifically, as long as the polymer compound layer 25 is interposed between the anode 22 and the separator 23, the polymer compound layer 25 may be disposed on a surface of the anode 22 or a surface of the separator 23.

Accordingly, the position where the polymer compound 24, 25 is provided on the separator 23 may be only a single surface or both surfaces of the separator 23. More specifically, the separator 23 has a surface facing the cathode 21 (a cathode-facing surface 23X) and a surface facing the anode 22 (an anode-facing surface 23Y). Accordingly, the polymer compound layer 24 may be provided on the cathode-facing surface 23X, and the polymer compound layer 25 may not be provided on the anode-facing surface 23Y. Alternatively, the polymer compound layer 24 may not be provided on the cathode-facing surface 23X, and the polymer compound layer 25 may be provided on the anode-facing surface 23Y. Alternatively, the polymer compound layer 24 may be provided on the cathode-facing surface 23X, and the polymer compound layer 25 may be provided on the anode-facing surface 23Y.

[Electrolytic Solution]

The spirally wound electrode body 20 is impregnated with the electrolytic solution as described above.

The electrolytic solution contains one or more of polymer compounds, and the polymer compound is dissolved in the electrolytic solution. Hereinafter, the polymer compound dissolved in the electrolytic solution is referred to as “dissolved polymer compound”.

The electrolytic solution contains the dissolved polymer compound for the following reason. A coating derived from the dissolved polymer compound is formed on each of the surface of the cathode 21 and the surface of the anode 22, and a similar coating is formed on each of a surface of the cathode active material and a surface of the anode active material. Moreover, even if each of the cathode active material layer 21B and the anode active material layer 22B is broken due to swelling and contraction during charge and discharge of the secondary battery, a coating is formed at a broken point (on a newly formed surface). In this case, each of the cathode 21 and the anode 22 is protected by the coating; therefore, each of the cathode 21 and the anode 22 is less prone to contact the electrolytic solution. This makes it possible to suppress decomposition reaction of the electrolytic solution. Accordingly, even if the secondary battery is repeatedly charged and discharged, discharge capacity is less prone to decrease, and gas resulting from the decomposition reaction of the electrolytic solution is less prone to be generated.

More specifically, the electrolytic solution may contain, for example, a nonaqueous solvent and an electrolyte salt in addition to the dissolved polymer compound. Accordingly, the dissolved polymer compound may be dissolved by the nonaqueous solvent.

The kind of the dissolved polymer compound is not particularly limited, as long as the dissolved polymer compound is one or more of any polymer compounds. In particular, the dissolved polymer compound may preferably contain one or more of polyvinylidene fluoride, polyethylene oxide, polyacrylonitrile, and poly(methyl methacrylate ethylene oxide ester) represented by the following formula (1), which makes it possible to achieve superior dissolubility and superior coating formation capability.

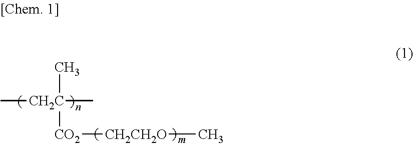

where n is an integer of 1 or more, and m is one or 1, 4, or 9.

As long as n is an integer or 1 or more, n is not particularly limited. It is to be noted that in a case in which n is 2 or more, the values of two or more m's may be the same as or different from one another. It goes without saying that the values of some of two or more m's may be the same as one another.

A weight-average molecular weight of the dissolved polymer compound is not particularly limited, but may be, for example, from 500 to 1000000 both inclusive, which makes it possible to achieve superior dissolubility.

A content of the dissolved polymer compound in the electrolytic solution is not particularly limited, but may be, for example, from 0.01 wt % to 10 wt % both inclusive, which makes it possible to achieve superior dissolubility and sufficient coating formation capability.

It is to be noted that it is possible to confirm the presence or absence of the dissolved polymer compound in the electrolytic solution and the kind of the dissolved polymer compound by the following procedure, for example.

First, the secondary battery is disassembled to collect the electrolytic solution. Subsequently, the electrolytic solution is left to stand, and the presence or absence of a precipitate in the electrolytic solution is visually checked. In a case in which the precipitate is present, an insoluble component is contained in the electrolytic solution. Accordingly, the insoluble component is removed from the electrolytic solution with use of a method such as a filtering method. It is to be noted that instead of checking the presence or absence of the precipitate, whether the Tyndall effect occurs may be visually checked with use of a light scattering effect of the electrolytic solution. In a case in which the Tyndall effect occurs, an insoluble component is contained in the electrolytic solution. Accordingly, the insoluble component is removed in a similar manner. It goes without saying that a method of checking the presence or absence of the precipitate and a method of checking the presence or absence of the Tyndall effect may be used in combination.

Next, the electrolytic solution from which the insoluble component is removed is dropped into a solvent (poor solvent) having low solubility with respect to the dissolved polymer compound, and an insoluble component is precipitated out of the electrolytic solution. Non-limiting examples of the poor solvent may include water, alcohol, and a mixture thereof. Non-limiting examples of the alcohol may include ethanol. Subsequently, the precipitate is collected from the electrolytic solution with use of a method such as a filtering method.

Lastly, whether the precipitate is the polymer compound (the dissolved polymer compound) is determined with use of one or more of existing analysis methods, and in a case in which the precipitate is the polymer compound, the composition of the polymer compound is determined. Non-limiting examples of the existing analysis methods may include a Fourier transform infrared spectroscopy (FT-IR) method, a nuclear magnetic resonance (NMR) method, and a gel permeation chromatography (GPC) method.

The nonaqueous solvent may contain, for example, one or more of solvents such as organic solvents. An electrolytic solution containing a nonaqueous solvent is a so-called nonaqueous electrolytic solution.

Non-limiting examples of the nonaqueous solvent may include a cyclic carbonate ester, a chain carbonate ester, a lactone, a chain carboxylate ester, and a nitrile (mononitrile), which make it possible to achieve, for example, high battery capacity, superior cycle characteristics, and superior storage characteristics. Non-limiting examples of the cyclic carbonate ester may include ethylene carbonate, propylene carbonate, butylene carbonate. Non-limiting examples of the chain carbonate ester may include dimethyl carbonate, diethyl carbonate, ethylmethyl carbonate, and methylpropyl carbonate. Non-limiting examples of the lactone may include γ-butyrolactone and γ-valerolactone. Non-limiting examples of the carboxylate ester may include methyl acetate, ethyl acetate, methyl propionate, ethyl propionate, propyl propionate, methyl butyrate, methyl isobutyrate, methyl trimethylacetate, and ethyl trimethylacetate. Non-limiting examples of the nitrile may include acetonitrile, methoxyacetonitrile, and 3-methoxypropionitrile.

In addition, non-limiting examples of the nonaqueous solvent may include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyl oxazolidinone, N,N′-dimethyl imidazolidinone, nitromethane, nitroethane, sulfolane, trimethyl phosphate, and dimethyl sulfoxide, which make it possible to achieve a similar advantage.

In particular, one or more of ethylene carbonate, propylene carbonate, dimethyl carbonate, diethyl carbonate, and ethylmethyl carbonate may be preferable, which make it possible to achieve, for example, higher battery capacity, further superior cycle characteristics, and further superior storage characteristics. In this case, a combination of a high-viscosity (high dielectric constant) solvent (having, for example, specific dielectric constant ∈≧30) such as ethylene carbonate and propylene carbonate and a low-viscosity solvent (having, for example, viscosity≦1 mPa·S) such as dimethyl carbonate, ethylmethyl carbonate, and diethyl carbonate may be more preferable. The combination allows for an improvement in the dissociation property of the electrolyte salt and ion mobility.

In particular, the nonaqueous solvent may contain one or more of an unsaturated cyclic carbonate ester, a halogenated carbonate ester, a sulfonate ester, an acid anhydride, a dicyano compound (dinitrile), and a diisocyanate compound, which make it possible to improve chemical stability of the electrolytic solution.

The unsaturated cyclic carbonate ester is a cyclic carbonate ester having one or more unsaturated bonds (carbon-carbon double bonds). Non-limiting examples of the unsaturated cyclic carbonate ester may include a vinylene carbonate-based compound, vinyl ethylene carbonate-based compound, and a methylene ethylene carbonate-based compound. A content of the unsaturated cyclic carbonate ester in the nonaqueous solvent is not particularly limited, but, may be, for example, from 0.01 wt % to 10 wt % both inclusive.

Non-limiting examples of the vinylene carbonate-based compound may include vinylene carbonate (1,3-dioxol-2-one), methylvinylene carbonate (4-methyl-1,3-dioxol-2-one), ethylvinylene carbonate (4-ethyl-1,3-dioxol-2-one), 4,5-dimethyl-1,3-dioxol-2-one, 4,5-diethyl-1,3-dioxol-2-one, 4-fluoro-1,3-dioxol-2-one, and 4-trifluoromethyl-1,3-dioxol-2-one.

Non-limiting examples of the vinyl ethylene carbonate-based compound may include vinyl ethylene carbonate (4-vinyl-1,3-dioxolane-2-one), 4-methyl-4-vinyl-1,3-dioxolane-2-one, 4-ethyl-4-vinyl-1,3-dioxolane-2-one, 4-n-propyl-4-vinyl-1,3-dioxolane-2-one, 5-methyl-4-vinyl-1,3-dioxolane-2-one, 4,4-divinyl-1,3-dioxolane-2-one, and 4,5-divinyl-1,3-dioxolane-2-one.

Non-limiting examples of the methylene ethylene carbonate-based compound may include methylene ethylene carbonate (4-methylene-1,3-dioxolane-2-one), 4,4-dimethyl-5-methylene-1,3-dioxolane-2-one, and 4,4-diethyl-5-methylene-1,3-dioxolane-2-one.

In addition, the unsaturated cyclic carbonate ester may be a catechol carbonate having a benzene ring.

The halogenated carbonate ester is a cyclic or chain carbonate ester containing one or more halogens as constituent elements. The kind of the halogen is not particularly limited, but non-limiting examples of the halogen may include fluorine (F), chlorine (CO, bromine (Br), and iodine (I). In particular, fluorine may be preferable. A content of the halogenated carbonate ester in the nonaqueous solvent is not particularly limited, but may be, for example, from 0.01 wt % to 50 wt % both inclusive.

Non-limiting examples of the cyclic halogenated carbonate ester may include 4-fluoro-1,3-dioxolane-2-one and 4,5-difluoro-1,3-dioxolane-2-one. Non-limiting examples of the chain halogenated carbonate ester may include fluoromethyl methyl carbonate, bis(fluoromethyl) carbonate, and difluoromethyl methyl carbonate.

Examples of the sulfonate ester may include a monosulfonate ester and a disulfonate ester. A content of the sulfonate ester in the nonaqueous solvent is not particularly limited, but may be, for example, from 0.5 wt % to 5 wt % both inclusive.

The monosulfonate ester may be a cyclic monosulfonate ester or a chain monosulfonate ester. Non-limiting examples of the cyclic monosulfonate ester may include sultone such as 1,3-propane sultone and 1,3-propene sultone. Non-limiting examples of the chain monosulfonate ester may include a compound in which a cyclic monosulfonate ester is cleaved at a middle site. It is to be noted that conditions such as the number of carbon atoms in the compound in which the cyclic monosulfonate ester is cleaved at a middle site may be freely changeable.

The disulfonate ester may be a cyclic disulfonate ester or a chain disulfonate ester. Non-limiting examples of the cyclic disulfonate ester may include compounds represented by formulas (2-1) to (2-3). Non-limiting examples of the chain disulfonate ester may include a compound in which a cyclic disulfonate ester is cleaved at a middle site. It is to be noted that conditions such as the number of carbon atoms in the compound in which the cyclic disulfonate ester is cleaved at a middle site may be freely changeable.

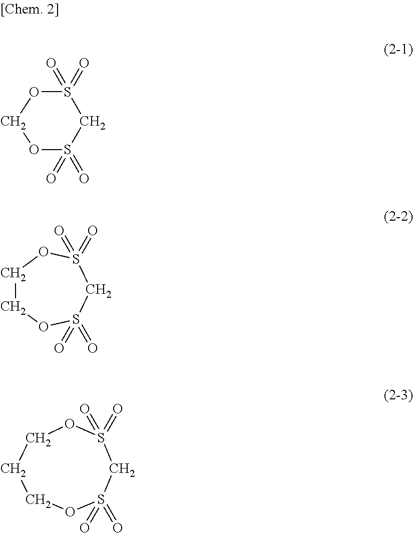 [SMILES: O=S1(=O)CS(=O)(=O)OCO1 ; O=S1(=O)CS(=O)(=O)OCCO1 ; O=S1(=O)CS(=O)(=O)OCCCO1]

Non-limiting examples of the acid anhydride may include a carboxylic anhydride, a disulfonic anhydride, and a carboxylic-sulfonic anhydride. A content of the acid anhydride in the nonaqueous solvent is not particularly limited, but may be, for example, from 0.5 wt % to 5 wt % both inclusive.

Non-limiting examples of the carboxylic anhydride may include succinic anhydride, glutaric anhydride, and maleic anhydride. Non-limiting examples of the disulfonic anhydride may include ethanedisulfonic anhydride and propanedisulfonic anhydride. Non-limiting examples of a carboxylic-sulfonic anhydride may include sulfobenzoic anhydride, sulfopropionic anhydride, and sulfobutyric anhydride.

Non-limiting examples of the dicyano compound may include a compound represented by NC—CₘH₂ₘ—CN (where m is an integer of 1 or more). A content of the dicyano compound in the nonaqueous solvent is not particularly limited, but may be, for example, from 0.5 wt % to 5 wt % both inclusive. Non-limiting examples of the dicyano compound may include succinonitrile (NC—C₂H₄—CN), glutaronitrile (NC—C₃H₆—CN), and adiponitrile (NC—C₄H₈—CN).

Non-limiting examples of the diisocyanate compound may include a compound represented by OCN—CₙH₂ₙ—NCO (where n is an integer of 1 or more). A content of the diisocyanate compound in the nonaqueous solvent is not particularly limited, but may be, for example, from 0.5 wt % to 5 wt % both inclusive. Non-limiting examples of the iisocyanate compound may include phenylene diisocyanate (OCN—C₆H₁₂—NCO).

However, the nonaqueous solvent may be a compound other than the compounds mentioned above.

The electrolyte salt may contain, for example, one or more of salts such as lithium salt. Note that the electrolyte salt may contain any salt other than the lithium salt. Non-limiting examples of the salt other than lithium may include a salt of a light metal other than lithium.

Non-limiting examples of the lithium salt may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr), which make it possible to achieve, for example, high battery capacity, superior cycle characteristics, and superior storage characteristics.

In particular, one or more of LiPF₆, LiBF₄, LiClO₄, and LiAsF₆ may be preferable, and LiPF₆ may be more preferable, which makes it possible to decrease the internal resistance, thereby achieving a higher effect.

In particular, the electrolyte salt may include one or more of compounds represented by formulas (3) to (5), which makes it possible to improve chemical stability of the electrolytic solution. Note that a plurality of R33's may be groups of a same kind or groups of different kinds. R41 to R43, and R51 and R52 may be similarly groups of a same kind or groups of different kinds.

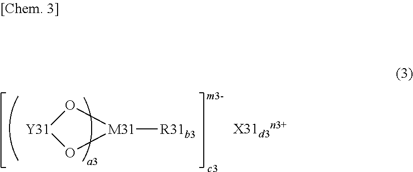

where X31 is one of Group 1 elements and Group 2 elements in the long form of the periodic table of the elements and aluminum (Al), M31 is one of transition metals and Group 13 elements, Group 14 elements, and Group 15 elements in the long form of the periodic table of the elements, R31 is a halogen group, Y31 is one of —C(═O)—R32-C(═O)—, —C(═O)—CR33₂- and —C(═O)—C(═O)—, R32 is one of an alkylene group, a halogenated alkylene group, an arylene group, and a halogenated arylene group, R33 is one of an alkyl group, a halogenated alkyl group, an aryl group, and a halogenated aryl group, a3 is an integer of 1 to 4, b3 is an integer of 0, 2, or 4, and each of c3, d3, m3, and n3 is an integer of 1 to 3.

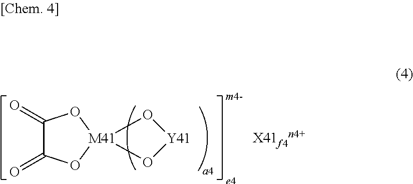

where X41 is one of Group 1 elements and Group 2 elements in the long form of the periodic table of the elements, M41 is one of transition metals, and Group 13 elements, Group 14 elements, and Group 15 elements in the long form of the periodic table of the elements, Y41 is one of —C(═O)—(CR41₂)_{b4}-C(═O)—, —R43₂C—(CR42₂)_{c4}-C(═O)—, —R43₂C—(CR42₂)_{c4}-CR43₂-, —R43₂C—(CR42₂)_{c4}-S(═O)₂—, —S(═O)₂—(CR42₂)_{d4}-S(═O)₂—, and —C(═O)—(CR42₂)_{d4}-S(═O)₂—, each of R41 and R43 is one of a hydrogen group, an alkyl group, a halogen group, and a halogenated alkyl group, one or more of R41 is one of the halogen group and the halogenated alkyl group, one or more of R43 are one of the halogen group and the halogenated alkyl group, R42 is one of a hydrogen group, an alkyl group, a halogen group, and a halogenated alkyl group, each of a4, e4, and n4 is an integer of 1 or 2, each of b4 and d4 is an integer of 1 to 4, c4 is an integer of 0 to 4, and each of f4 and m4 is an integer of 1 to 3.

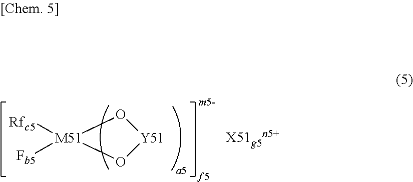

where X51 is one of Group 1 elements and Group 2 elements in the long form of the periodic table of the elements, M51 is one of transition metals, and Group 13 elements, Group 14 elements, and Group 15 elements in the long form of the periodic table of the elements, Rf is one of a fluorinated alkyl group and a fluorinated aryl group, the number of carbon atoms in each of the fluorinated alkyl group and the fluorinated aryl group is 1 to 10, Y51 is one of —C(═O)—(CR51₂)_{d5}-C(═O)—, —R52₂C—(CR51₂)_{d5}-C(═O)—, —R52₂C—(CR51₂)_{d5}-CR52₂-, —R52₂C—(CR51₂)_{d5}-S(═O)₂—, —S(═O)₂—(CR51₂)ₑ₅-S(═O)₂—, and —C(═O)—(CR51₂)ₑ₅-S(═O)₂—, R51 is one of a hydrogen group, an alkyl group, a halogen group, and a halogenated alkyl group, R52 is one of a hydrogen group, an alkyl group, a halogen group, and a halogenated alkyl group, one or more of R52 are one of the halogen group and the halogenated alkyl group, each of a5, f5, and n5 is an integer of 1 or 2, each of b5, c5, and e5 is an integer of 1 to 4, d5 is an integer of 0 to 4, and each of g5 and m5 is an integer of 1 to 3.

It is to be noted that the Group 1 elements include hydrogen (H), lithium (Li), sodium (Na), potassium (K), rubidium (Rb), cesium (Cs), and francium (Fr). The Group 2 elements include beryllium (Be), magnesium (Mg), calcium (Ca), strontium (Sr), barium (Ba), and radium (Ra). The Group 13 elements include boron (B), aluminum (Al), gallium (Ga), indium (In), and thallium (Tl). The Group 14 elements include carbon (C), silicon (Si), germanium (Ge), tin (Sn), and lead (Pb). The Group 15 elements include nitrogen (N), phosphorus (P), arsenic (As), antimony (Sb), and bismuth (Bi).

Non-limiting examples of the compound represented by the formula (3) may include compounds represented by respective formulas (3-1) to (3-6). Non-limiting examples of the compound represented by the formula (4) may include compounds represented by respective formulas (4-1) to (4-8). Non-limiting examples of the compound represented by the formula (5) may include a compound represented by a formula (5-1).

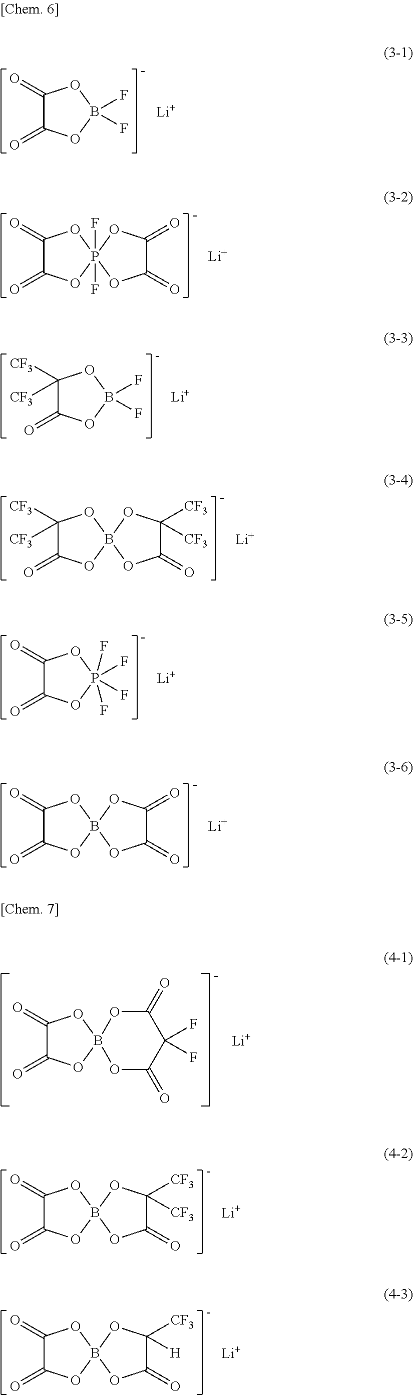

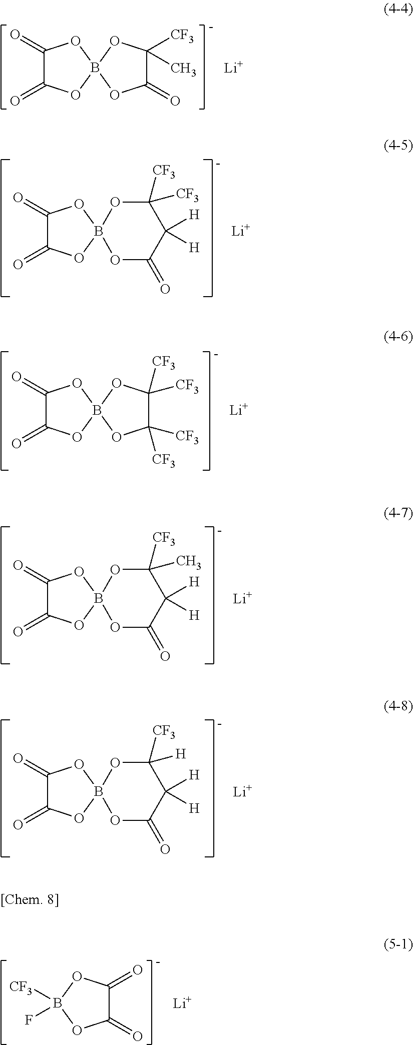

Moreover, the electrolyte salt may contain one or more of compounds represented by respective formulas (6) and (8), which makes it possible to improve chemical stability of the electrolytic solution. It is to be noted that the values of m and n may be the same as or different from each other. The values of p, q, and r may be similarly the same as or different from one another.

LiN(CₘF₂ₘ₊₁SO₂)(CₙF₂ₙ₊₁SO₂) (6)

where each of m and n is an integer of 1 or more.

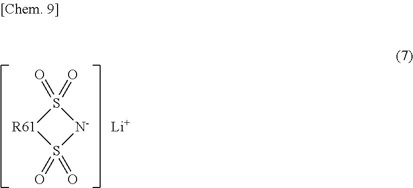

where R61 is a straight-chain or branched perfluoroalkylene group having 2 to 4 carbon atoms.

LiC(CₚF₂ₚ₊₁SO₂)(C_{q}F_{2q+1}SO₂)(CᵣF₂ᵣ₊₁SO₂) (8)

where each of p, q, and r is an integer of 1 or more.

The compound represented by the formula (6) is a cyclic imide compound. Non-limiting examples of the cyclic imide compound may include lithium bis(fluorosulfonyl)imide (LiN(SO₂F)₂), lithium bis(trifluoromethanesulfonyl)imide (LiN(CF₃SO₂)₂), lithium bis(trifluoroethanesulfonyl)imide (LiN(C₂F₅SO₂)₂), lithium (trifluoromethanesulfonyl)(pentafluoroethanesulfonyl)imide (LiN(CF₃SO₂)(C₂F₅SO₂)), lithium (trifluoromethanesulfonyl)(heptafluoropropanesulfonyl)imide (LiN(CF₃SO₂)(C₃F₇SO₂)), and lithium (trifluoromethanesulfonyl)(nonafluorobutanesulfonyl)imide (LiN(CF₃SO₂)(C₄F₉SO₂)).

The compound represented by the formula (7) is a cyclic imide compound. Non-limiting examples of the cyclic imide compound may include compounds represented by formulas (7-1) to (7-4).

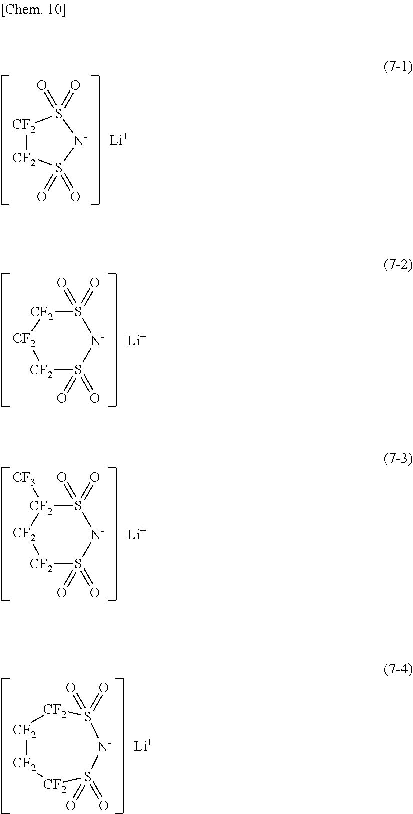

The compound represented by the formula (8) is a chain methide compound. Non-limiting examples of the chain methide compound may include lithium tris (trifluoromethanesulfonyl) methide (LiC(CF₃SO₂)₃).

However, the electrolyte salt may be a compound other than the compounds mentioned above.

A content of the electrolyte salt is not particularly limited, but, in particular, may be preferably from 0.3 mol/kg to 3.0 mol/kg both inclusive with respect to the solvent, which makes it possible to achieve high ionic conductivity.

[Operation of Secondary Battery]

The secondary battery may operate as follows, for example.

When the secondary battery is charged, lithium ions are extracted from the cathode 21, and the extracted lithium ions are inserted in the anode 22 through the electrolytic solution. In contrast, when the secondary battery is discharged, lithium ions are extracted from the anode 22, and the extracted lithium ions are inserted in the cathode 21 through the electrolytic solution.

[Method of Manufacturing Secondary Battery]

The secondary battery may be manufactured by the following procedure, for example.

When fabricating the cathode 21, first, the cathode active material, and, on as-necessary basis, for example, the cathode binder and the cathode conductor are mixed to obtain a cathode mixture. Subsequently, the cathode mixture is dispersed in, for example, an organic solvent to obtain paste cathode mixture slurry. Next, both surfaces of the cathode current collector 21A are coated with the cathode mixture slurry, and thereafter, the coated cathode mixture slurry is dried to form the cathode active material layers 21B. Thereafter, the cathode active material layers 21B are compression-molded with use of, for example, a roll pressing machine, while being heated on as-necessary basis. In this case, the cathode active material layer 21B may be compression-molded a plurality of times.

When fabricating the anode 22, the anode active material layer 22B is formed on the anode current collector 22A by a similar procedure to the foregoing procedure of fabricating the cathode 21. More specifically, the anode active material, and, on as-necessary basis, for example, the anode binder and the anode conductor are mixed to obtain an anode mixture. Subsequently, the anode mixture is dispersed in, for example, an organic solvent to obtain paste anode mixture slurry. Next, both surfaces of the anode current collector 22A are coated with the anode mixture slurry, and thereafter, the coated anode mixture slurry is dried to form the anode active material layer 22B. Lastly, the anode active material layer 22B is compression-molded with use of, for example, a roll pressing machine.

When preparing the electrolytic solution, the electrolyte salt is dissolved in the nonaqueous solvent, and thereafter, the dissolved polymer compound is dissolved in the nonaqueous solvent in which the electrolyte salt is dissolved.

When assembling the secondary battery using the cathode 21 and the anode 22, the cathode lead 25 is attached to the cathode current collector 21A by, for example, a welding method, and the anode lead 26 is attached to the anode current collector 22A by, for example, a welding method. Subsequently, the cathode 21 and the anode 22 are stacked with the separator 23 in between, and the cathode 21, the anode 22, and the separator 23 are spirally wound to form the spirally wound electrode body 20. Thereafter, the center pin 24 is inserted in the center of the spirally wound electrode body 20.

Herein, when forming the polymer compound layer 24, the fluorine-containing polymer compound is dissolved in, for example, an organic solvent to prepare a process solution. Subsequently, the cathode-facing surface 23X of the separator 23 is coated with the process solution, and thereafter, the process solution is dried to volatilize the organic solvent in the process solution, and form a film of the fluorine-containing polymer compound. Thus, the polymer compound layer 24 is formed. Note that instead of coating with the process solution, the separator 23 may be immersed in the process solution, and thereafter, the separator 23 may be taken out of the process solution, and then, the process solution may be dried. Even in this case, a film of the fluorine-containing polymer compound is formed to form the polymer compound layer 24.

It is to be noted that a procedure of forming the polymer compound layer 25 is similar to the above-described procedure of forming the polymer compound layer 24.

Subsequently, the spirally wound electrode body 20 is sandwiched between the pair of insulating plates 12 and 13, and is contained inside the battery can 11. In this case, an end tip of the cathode lead 25 is attached to the safety valve mechanism 15 by, for example, a welding method, and an end tip of the anode lead 26 is attached to the battery can 11 by, for example, a welding method. Subsequently, the electrolytic solution is injected inside the battery can 11, and the separator 23 is impregnated with the injected electrolytic solution. Thereafter, the battery cover 14, the safety valve mechanism 15, and the PTC device 16 are swaged with the gasket 17 at the open end of the battery can 11. Thus, the cylindrical type secondary battery is completed.

[Action and Effects of Secondary Battery]

According to the secondary battery, the dissolved polymer compound is dissolved in the electrolytic solution, which makes it possible to suppress decomposition reaction of the electrolytic solution, as described above. Accordingly, even if the secondary battery is repeatedly charged and discharged, discharge capacity is less prone to decrease, and gas is less prone to be generated, which makes it possible to achieve superior battery characteristics.

In particular, the dissolved polymer compound containing one or more polymer compounds such as polyvinylidene fluoride makes it possible to achieve superior dissolubility and superior coating formation capability, thereby achieving a higher effect.

Moreover, when the polymer compound layer 24 is provided between the cathode 21 and the separator 23, even if the secondary battery is repeatedly charged and discharged, the resistance of the secondary battery is less prone to increase, and the secondary battery is less prone to be swollen, as described above, which makes it possible to achieve a higher effect. The effect is similarly achievable in a case in which the polymer compound layer 25 is provided between the anode 22 and the separator 23.

In this case, when each of the polymer compound layers 24 and 25 contains the fluorine-containing polymer compound, superior physical strength and electrochemical stability are achievable as described above, which makes it possible to achieve a higher effect.

<1-2. Lithium-Ion Secondary Battery (Laminated Film Type)>

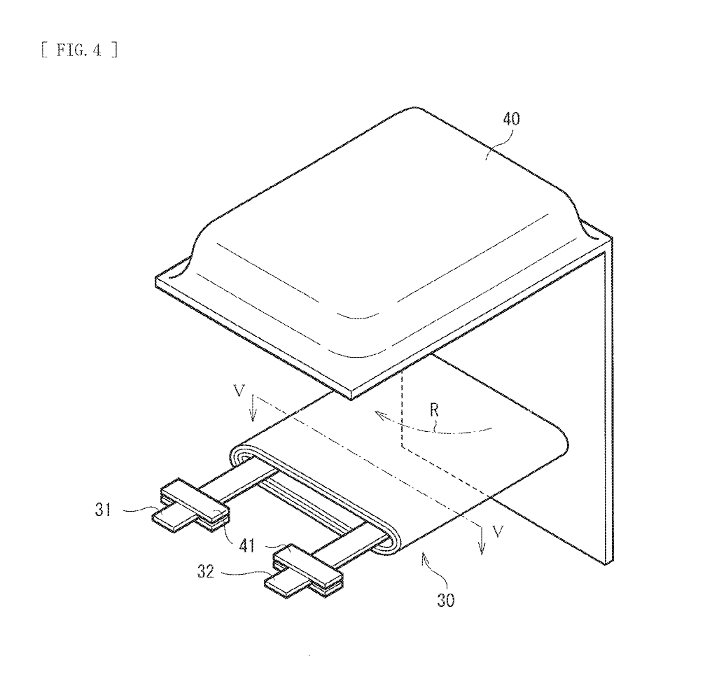

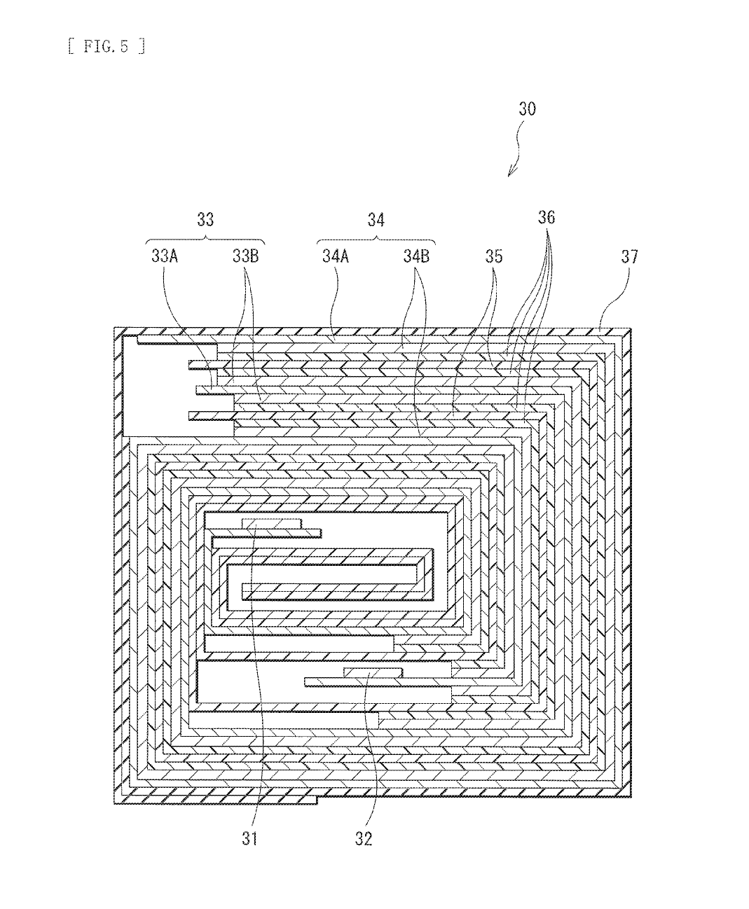

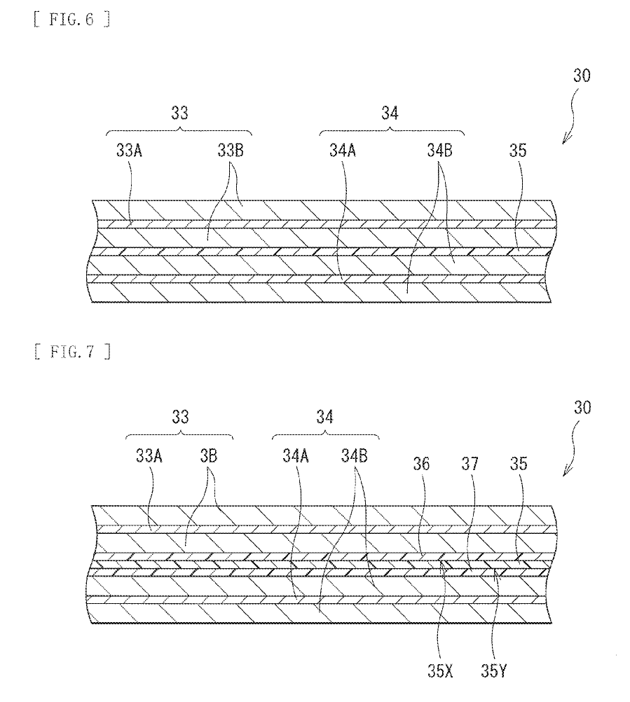

FIG. 4 illustrates a perspective configuration of another secondary battery, and FIG. 5 illustrates a cross-section taken along a line V-V of a spirally wound electrode body 30 illustrated in FIG. 4. FIG. 6 illustrates a cross-sectional configuration of part of the spirally wound electrode body 30 illustrated in FIG. 5. FIG. 7 illustrates another cross-sectional configuration of part of the spirally wound electrode body 30. It is to be noted that FIG. 4 illustrates a state in which the spirally wound electrode body 30 and an outer package member 40 are separated from each other. In description below, the components of the cylindrical type secondary battery that have been already described are used where appropriate.

[Whole Configuration of Secondary Battery]

The secondary battery may be, for example, a so-called laminated film type lithium-ion secondary battery. For example, the spirally wound electrode body 30 may be contained inside the film-like outer package member 40 as illustrated in FIG. 4. In the spirally wound electrode body 30, for example, a cathode 33 and an anode 34 may be stacked with a separator 35 and an electrolyte layer 36 in between, and the cathode 33, the anode 34, the separator 35, and the electrolyte layer 36 may be spirally wound. A cathode lead 31 is attached to the cathode 33, and an anode lead 32 is attached to the anode 34. An outermost periphery of the spirally wound electrode body 30 is protected by a protective tape 37.

Each of the cathode lead 31 and the anode lead 32 may be led out from inside to outside of the outer package member 40 in a same direction, for example. The cathode lead 31 may be made of, for example, one or more of conductive materials such as aluminum. The anode lead 32 may be made of, for example, one or more of conductive materials such as copper, nickel, and stainless steel. These conductive materials may have a thin-plate shape or a mesh shape, for example.

The outer package member 40 may be, for example, one film that is foldable in a direction of an arrow R illustrated in FIG. 4, and the outer package member 40 may have a depression for containing of the spirally wound electrode body 30 in part thereof. The outer package member 40 may be a laminated film in which a fusion bonding layer, a metal layer, and a surface protective layer are laminated in this order, for example. In a process of manufacturing the secondary battery, the outer package member 40 is folded so that portions of the fusion-bonding layer face each other with the spirally wound electrode body 30 in between, and thereafter outer edges of the portions of the fusion bonding layer are fusion-bonded. Alternatively, two laminated films bonded to each other by, for example, an adhesive may form the outer package member 40. Examples of the fusion bonding layer may include a film made of one or more of polyethylene, polypropylene, and other materials. The metal layer may include, for example, one or more of an aluminum foil and other metal materials. The surface protective layer may be, for example, a film made of one or more of nylon, polyethylene terephthalate, and other materials.

In particular, the outer package member 40 may preferably be an aluminum laminated film in which a polyethylene film, an aluminum foil, and a nylon film are laminated in this order. However, the outer package member 40 may be a laminated film having any other laminated structure, a polymer film such as polypropylene, or a metal film.

An adhesive film 41 for prevention of outside air intrusion may be inserted between the outer package member 40 and the cathode lead 31, and the adhesive film 41 is also inserted between the outer package member 40 and the anode lead 32. The adhesive film 41 is made of a material having adhesibility with respect to the cathode lead 31 and the anode lead 32. Non-limiting examples of the material having adhesibility may include a polyolefin resin. More specific examples thereof may include one or more of polyethylene, polypropylene, modified polyethylene, and modified polypropylene.

[Cathode, Anode, and Separator]

As illustrated in FIGS. 5 and 6, the cathode 33 may include, for example, a cathode current collector 33A and a cathode active material layer 33B, and the anode 34 may include, for example, an anode current collector 34A and an anode active material layer 34B. The configurations of the cathode current collector 33A, the cathode active material layer 33B, the anode current collector 34A, and the anode active material layer 34B are similar to the configurations of the cathode current collector 21A, the cathode active material layer 21B, the anode current collector 22A, and the anode active material layer 22B, respectively. The configuration of the separator 35 is similar to the configuration of the separator 23.

It goes without saying that a polymer compound layer 36 may be formed between the cathode 33 and the separator 35, and a polymer compound layer 37 may be formed between the anode 34 and the separator 35, as illustrated in FIG. 7. In particular, the polymer compound layer 36 may be preferably formed on a cathode-facing surface 35X of the separator 35, and the polymer compound layer 37 may be preferably formed on an anode-facing surface 35Y of the separator 35.

[Electrolyte Layer]

The electrolyte layer 36 may include, for example, an electrolytic solution and a polymer compound that is not dissolved in the electrolytic solution. Accordingly, the cathode 33, the anode 34, and the electrolytic solution included in the electrolyte layer 36 are contained inside the film-like outer package member 40. Hereinafter, as distinguished from the foregoing polymer compound (the dissolved polymer compound) dissolved in the electrolytic solution, the polymer compound that is not dissolved in the electrolytic solution is referred to as “non-dissolved polymer compound”. It is to be noted that illustration of the electrolyte layer 36 is omitted from FIGS. 6 and 7.

In the electrolyte layer 36, the electrolytic solution is held by the non-dissolved polymer compound. The electrolyte layer 36 described here is a so-called gel electrolyte. The gel electrolyte achieves high ionic conductivity (for example, 1 mS/cm or more at room temperature), and prevents liquid leakage of the electrolytic solution.

The electrolyte layer 36 may further include one or more of other materials such as an additive in addition to the electrolyte solution and the non-dissolved polymer compound.

The non-dissolved polymer compound may contain, for example, one or more of polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, poly(methyl methacrylate), polyacrylic acid, polymethacrylic acid, styrene-butadiene rubber, nitrile-butadiene rubber, polystyrene, and polycarbonate. In addition thereto, the non-dissolved polymer compound may be a copolymer. The copolymer may be, for example, a copolymer of vinylidene fluoride and hexafluoropylene. In particular, polyvinylidene fluoride may be preferable as a homopolymer, and a copolymer of vinylidene fluoride and hexafluoropylene may be preferable as a copolymer. Such polymer compounds are electrochemically stable.

For example, the composition of the electrolytic solution may be similar to the composition of the electrolytic solution used in the cylindrical type secondary battery. In other words, the electrolytic solution contains the dissolved polymer compound. However, the solvent used for the electrolyte layer 36 that is a gel electrolyte encompasses not only a liquid material (a nonaqueous solvent) but also a material having ionic conductivity that has ability to dissociate the electrolyte salt. Hence, in a case in which a polymer compound having ionic conductivity is used, the polymer compound is also encompassed by the solvent.

It is to be noted that the electrolytic solution may be used as it is instead of the gel electrolyte layer 36. In this case, the spirally wound electrode body 30 is impregnated with the electrolytic solution.

[Operation of Secondary Battery]

The secondary battery may operate, for example, as follows.

When the secondary battery is charged, lithium ions are extracted from the cathode 33, and the extracted lithium ions are inserted in the anode 34 through the electrolyte layer 36. In contrast, when the secondary battery is discharged, lithium ions are extracted from the anode 34, and the extracted lithium ions are inserted in the cathode 33 through the electrolyte layer 36.

[Method of Manufacturing Secondary Battery]

The secondary battery including the gel electrolyte layer 36 may be manufactured, for example, by one of the following three procedures.

In a first procedure, the cathode 33 and the anode 34 are fabricated by a similar fabrication procedure to that of the cathode 21 and the anode 22. More specifically, the cathode 33 is fabricated by forming the cathode active material layer 33B on both surfaces of the cathode current collector 33A, and the anode 34 is fabricated by forming the anode active material layer 34B on both surfaces of the anode current collector 34A. Subsequently, for example, the electrolytic solution containing the dissolved polymer compound, the non-dissolved polymer compound, and an organic solvent are mixed to prepare a precursor solution. Subsequently, each of the cathode 33 and the anode 34 is coated with the precursor solution, and the coated precursor solution is dried to form the gel electrolyte layer 36. Subsequently, the cathode lead 31 is attached to the cathode current collector 33A by, for example, a welding method, and the anode lead 32 is attached to the anode current collector 34A by, for example, a welding method. Subsequently, the cathode 33 and the anode 34 are stacked with the separator 35 in between, and the cathode 33, the anode 34, and the separator 35 are spirally wound to fabricate the spirally wound electrode body 30. Thereafter, the protective tape 37 is attached onto the outermost periphery of the spirally wound body 30. Subsequently, the outer package member 40 is folded to interpose the spirally wound electrode body 30, and thereafter, the outer edges of the outer package member 40 are bonded by, for example, a thermal fusion bonding method to enclose the spirally wound electrode body 30 in the outer package member 40. In this case, the adhesive films 41 are inserted between the cathode lead 31 and the outer package member 40 and between the anode lead 32 and the outer package member 40.

In a second procedure, the cathode lead 31 is attached to the cathode 33, and the anode lead 32 is attached to the anode 34. Subsequently, the cathode 33 and the anode 34 are stacked with the separator 35 in between and are spirally wound to fabricate a spirally wound body as a precursor of the spirally wound electrode body 30. Thereafter, the protective tape 37 is adhered to the outermost periphery of the spirally wound body. Subsequently, the outer package member 40 is folded to interpose the spirally wound electrode body 30, and thereafter, the outer edges other than one side of the outer package member 40 are bonded by, for example, a thermal fusion bonding method, and the spirally wound body is contained inside a pouch formed of the outer package member 40. Subsequently, the electrolytic solution, monomers that are raw materials of the non-dissolved polymer compound, a polymerization initiator, and, on as-necessary basis, other materials such as a polymerization inhibitor are mixed to prepare a composition for electrolyte. Subsequently, the composition for electrolyte is injected inside the pouch formed of the outer package member 40. Thereafter, the pouch formed of the outer package member 40 is hermetically sealed by, for example, a thermal fusion bonding method. Subsequently, the monomers are thermally polymerized to form the non-dissolved polymer compound. The gel electrolyte layer 36 is thereby formed.

In a third procedure, the spirally wound body is fabricated and contained inside the pouch formed of the outer package member 40 in a similar manner to that of the second procedure described above, except that the separator 35 on which the polymer compound layers 36 and 37 are formed is used. Subsequently, the electrolytic solution is prepared and injected inside the pouch formed of the outer package member 40. Thereafter, an opening of the pouch formed of the outer package member 40 is hermetically sealed by, for example, a thermal fusion bonding method. Subsequently, the resultant is heated while a weight is applied to the outer package member 40 to cause the separator 35 to be closely attached to the cathode 33 with the polymer compound layer 36 in between and to cause the separator 35 to be closely attached to the anode 34 with the polymer compound layer 37 in between. Thus, the polymer compound layers 36 and 37 are each impregnated with the electrolytic solution, and the polymer compound layers 36 and 37 are each gelated, thereby forming the electrolyte layer 36. In this case, the fluorine-containing polymer compound contained in each of the polymer compound layers 36 and 37 serves as the non-dissolved polymer compound.

In the third procedure, swollenness of the secondary battery is suppressed more than in the first procedure. Further, in the third procedure, for example, the nonaqueous solvent, and the monomers that are the raw materials of the polymer compound are hardly left in the electrolyte layer 36, as compared with in the second procedure. Accordingly, the formation process of the non-dissolved polymer compound is favorably controlled. As a result, each of the cathode 33, the anode 34, and the separator 35 is sufficiently and closely attached to the electrolyte layer 36.

[Action and Effects of Secondary Battery]

According to the secondary battery, the dissolved polymer compound is dissolved in the electrolytic solution contained in the electrolyte layer 36. Therefore, superior battery characteristics are achievable for a similar reason to the reason in the foregoing cylindrical type secondary battery. In particular, in a case in which the film-like outer package member 40 is used, the secondary battery is inherently easily swollen. It is therefore possible to further suppress swollenness of the secondary battery resulting from decomposition reaction of the electrolytic solution. Action and effects other than those described above are similar to those of the cylindrical type secondary battery.

<1-3. Lithium Metal Secondary Battery>

A secondary battery described here is a cylindrical type secondary battery (lithium metal secondary battery) in which the capacity of the anode 22 is obtained by precipitation and dissolution of lithium metal. The secondary battery has a similar configuration to that of the foregoing lithium ion secondary battery (cylindrical type), and is manufactured by a similar procedure, except that the anode active material layer 22B is made of the lithium metal.

In the secondary battery, the lithium metal is used as an anode active material, and high energy density is thereby achievable. The anode active material layer 22B may exist at the time of assembling, or the anode active material layer 22B may not necessarily exist at the time of assembling and may be made of the lithium metal precipitated during charge. Further, the anode active material layer 22B may be used as a current collector, and the anode current collector 22A may be omitted.

The secondary battery may operate, for example, as follows. When the secondary battery is charged, lithium ions are extracted from the cathode 21, and the extracted lithium ions are precipitated as the lithium metal on the surface of the anode current collector 22A through the electrolytic solution. In contrast, when the secondary battery is discharged, the lithium metal is eluded as lithium ions from the anode active material layer 22B, and is inserted in the cathode 21 through the electrolytic solution.

According to the cylindrical type lithium metal secondary battery, the dissolved polymer compound is dissolved in the electrolytic solution. Therefore, superior battery characteristics are achievable for a similar reason to the reason in the cylindrical type lithium-ion secondary battery.

It is to be noted that the lithium metal secondary battery described here is not limited to the cylindrical type secondary battery, and may be a laminated film type secondary battery. Even in this case, similar effects are achievable.

<2. Applications of Secondary Battery>

Next, description is given of application examples of any of the secondary batteries mentioned above.

Applications of the secondary battery are not particularly limited as long as the secondary battery is applied to, for example, a machine, a device, an instrument, an apparatus, and a system (a collective entity of, for example, a plurality of devices) that are able to use the secondary battery as a driving power source, an electric power storage source for electric power accumulation, or any other source. The secondary battery used as the power source may be a main power source (a power source used preferentially), or may be an auxiliary power source (a power source used instead of the main power source or used being switched from the main power source). In a case in which the secondary battery is used as the auxiliary power source, the kind of the main power source is not limited to the secondary battery.

Examples of the applications of the secondary battery may include electronic apparatuses (including portable electronic apparatuses) such as a video camcorder, a digital still camera, a mobile phone, a notebook personal computer, a cordless phone, a headphone stereo, a portable radio, a portable television, and a portable information terminal. Further examples thereof may include: a mobile lifestyle appliance such as an electric shaver; a storage device such as a backup power source and a memory card; an electric power tool such as an electric drill and an electric saw; a battery pack used as an attachable and detachable power source of, for example, a notebook personal computer; a medical electronic apparatus such as a pacemaker and a hearing aid; an electric vehicle such as an electric automobile (including a hybrid automobile); and an electric power storage system such as a home battery system for accumulation of electric power for, for example, emergency. It goes without saying that the secondary battery may be employed for an application other than the applications mentioned above.

In particular, the secondary battery is effectively applicable to, for example but not limited to, the battery pack, the electric vehicle, the electric power storage system, the electric power tool, and the electronic apparatus. In these applications, superior battery characteristics are demanded, and using the secondary battery of the technology makes it possible to effectively improve performance. It is to be noted that the battery pack is a power source that uses the secondary battery, and may be, for example, a so-called assembled battery. The electric vehicle is a vehicle that operates (runs) using the secondary battery as a driving power source, and may be an automobile (such as a hybrid automobile) that includes together a drive source other than the secondary battery, as described above. The electric power storage system is a system that uses the secondary battery as an electric power storage source. For example, in a home electric power storage system, electric power is accumulated in the secondary battery that is the electric power storage source, which makes it possible to use, for example, home electric products with use of the accumulated electric power. The electric power tool is a tool in which a movable section (such as a drill) is allowed to be moved with use of the secondary battery as a driving power source. The electronic apparatus is an apparatus that executes various functions with use of the secondary battery as a driving power source (an electric power supply source).

Hereinafter, specific description is given of some application examples of the secondary battery. It is to be noted that configurations of the respective application examples described below are mere examples, and may be changed as appropriate.

<2-1. Battery Pack (Single Battery)>

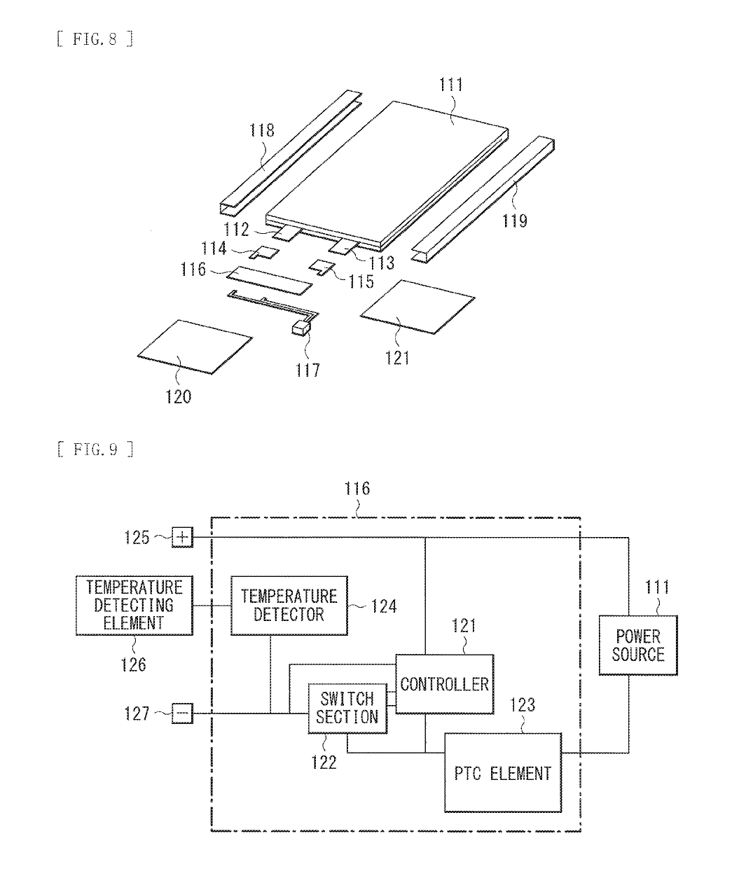

FIG. 8 illustrates a perspective configuration of a battery pack using a single battery. FIG. 9 illustrates a block configuration of the battery pack illustrated in FIG. 8. It is to be noted that FIG. 8 illustrates the battery back in an exploded state.

The battery back described here is a simple battery pack using one secondary battery (a so-called soft pack), and is mounted in, for example, an electronic apparatus typified by a smartphone. For example, the battery pack may include a power source 111 that is the laminated film type secondary battery, and a circuit board 116 coupled to the power source 111, as illustrated in FIG. 8. A cathode lead 112 and an anode lead 113 are attached to the power source 111.

A pair of adhesive tapes 118 and 119 are adhered to both side surfaces of the power source 111. A protection circuit module (PCM) is formed in the circuit board 116. The circuit board 116 is coupled to the cathode lead 112 through a tab 114, and is coupled to the anode lead 113 through a tab 115. Moreover, the circuit board 116 is coupled to a lead 117 provided with a connector for external connection. It is to be noted that while the circuit board 116 is coupled to the power source 111, the circuit board 116 is protected from upper side and lower side by a label 120 and an insulating sheet 121. The label 120 is adhered to fix, for example, the circuit board 116 and the insulating sheet 121.

Moreover, for example, the battery pack may include the power source 111 and the circuit board 116 as illustrated in FIG. 9. The circuit board 116 may include, for example, a controller 121, a switch section 122, a PTC element 123, and a temperature detector 124. The power source 111 is connectable to outside through a cathode terminal 125 and an anode terminal 127, and is thereby charged and discharged through the cathode terminal 125 and the anode terminal 127. The temperature detector 124 is allowed to detect a temperature with use of a temperature detection terminal (a so-called T terminal) 126.

The controller 121 controls an operation of the entire battery pack (including a used state of the power source 111), and may include, for example, a central processing unit (CPU) and a memory.

For example, in a case in which a battery voltage reaches an overcharge detection voltage, the controller 121 may so cause the switch section 122 to be disconnected that a charge current does not flow into a current path of the power source 111. Moreover, for example, in a case in which a large current flows during charge, the controller 121 may cause the switch section 122 to be disconnected, thereby blocking the charge current.

In addition, for example, in a case in which the battery voltage reaches an overdischarge detection voltage, the controller 121 may so cause the switch section 122 to be disconnected that a discharge current does not flow into the current path of the power source 111. Moreover, for example, in a case in which a large current flows during discharge, the controller 121 may cause the switch section 122 to be disconnected, thereby blocking the discharge current.

It is to be noted that the overcharge detection voltage of the secondary battery may be, for example, 4.20 V±0.05 V, and the overdischarge detection voltage may be, for example, 2.4 V±0.1 V.

The switch section 122 switches the used state of the power source 111 (whether the power source 111 is connectable to an external device) in accordance with an instruction from the controller 121. The switch section 122 may include, for example, a charge control switch and a discharge control switch. The charge control switch and the discharge control switch may each be, for example, a semiconductor switch such as a field-effect transistor using a metal oxide semiconductor (MOSFET). It is to be noted that the charge current and the discharge current may be detected on the basis of on-resistance of the switch section 122.

The temperature detector 124 measures a temperature of the power source 111, and outputs a result of the measurement to the controller 121. The temperature detector 124 may include, for example, a temperature detecting element such as a thermistor. It is to be noted that the result of the measurement by the temperature detector 124 may be used, for example, but not limited to, in a case in which the controller 121 performs charge and discharge control at the time of abnormal heat generation and in a case in which the controller 121 performs a correction process at the time of calculating remaining capacity.

It is to be noted that the circuit board 116 may not include the PTC element 123. In this case, a PTC element may be separately attached to the circuit board 116.

<2-2. Battery Pack (Assembled Battery)>

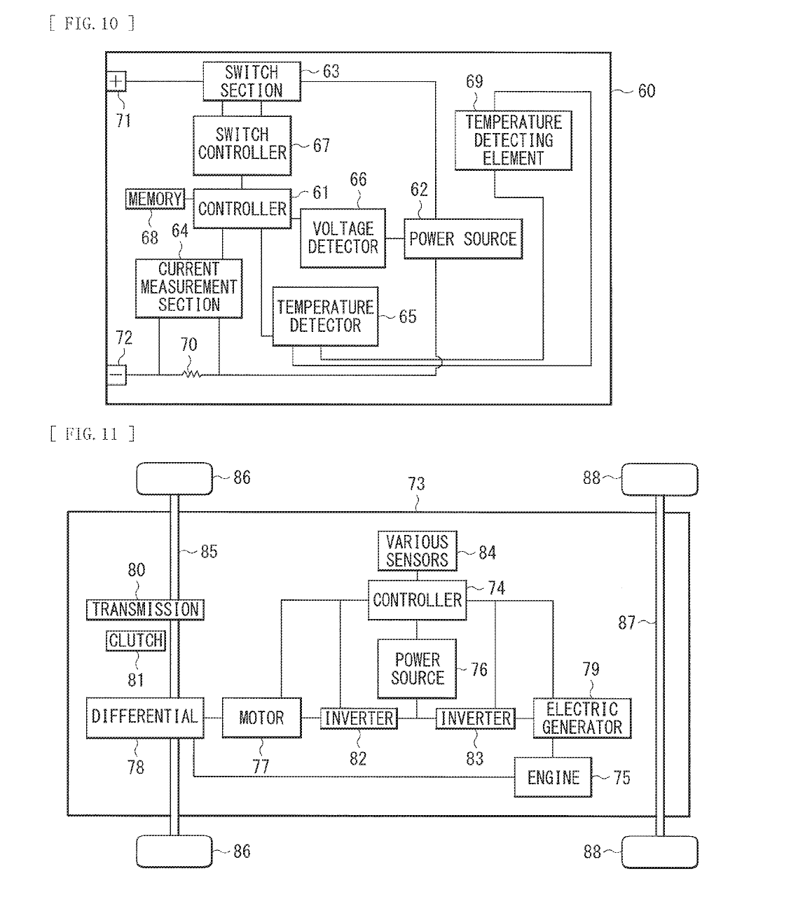

FIG. 10 illustrates a block configuration of a battery pack using an assembled battery. For example, the battery pack may include a controller 61, a power source 62, a switch section 63, a current measurement section 64, a temperature detector 65, a voltage detector 66, a switch controller 67, a memory 68, a temperature detecting element 69, a current detection resistance 70, a cathode terminal 71, and an anode terminal 72 inside a housing 60. The housing 60 may be made of, for example, a plastic material.

The controller 61 controls an operation of the entire battery pack (including a used state of the power source 62), and may include, for example, a CPU. The power source 62 includes one or more secondary batteries. The power source 62 may be, for example, an assembled battery that includes two or more secondary batteries. The secondary batteries may be connected in series, in parallel, or in series-parallel combination. To give an example, the power source 62 may include six secondary batteries in which two sets of series-connected three batteries are connected in parallel to each other.

The switch section 63 switches the used state of the power source 62 (whether the power source 62 is connectable to an external device) in accordance with an instruction from the controller 61. The switch section 63 may include, for example, a charge control switch, a discharge control switch, a charging diode, and a discharging diode. The charge control switch and the discharge control switch may each be, for example, a semiconductor switch such as a field-effect transistor that uses a metal oxide semiconductor (a MOSFET).

The current measurement section 64 measures a current with the use of the current detection resistance 70, and outputs a result of the measurement to the controller 61. The temperature detector 65 measures a temperature with the use of the temperature detecting element 69, and outputs a result of the measurement to the controller 61. The result of the temperature measurement may be used, for example, but not limited to, in a case in which the controller 61 performs charge and discharge control at the time of abnormal heat generation and in a case in which the controller 61 performs a correction process at the time of calculating remaining capacity. The voltage detector 66 measures voltages of the secondary batteries in the power source 62, performs analog-to-digital conversion on the measured voltage, and supplies the resultant to the controller 61.

The switch controller 67 controls an operation of the switch section 63 in accordance with signals inputted from the current measurement section 64 and the voltage detector 66.

For example, in a case in which a battery voltage reaches an overcharge detection voltage, the switch controller 67 may so cause the switch section 63 (the charge control switch) to be disconnected that a charge current does not flow into a current path of the power source 62. This makes it possible to perform only discharge through the discharging diode in the power source 62. It is to be noted that, for example, when a large current flows during charge, the switch controller 67 may block the charge current.

Further, for example, in a case in which the battery voltage reaches an overdischarge detection voltage, the switch controller 67 may so cause the switch section 63 (the discharge control switch) to be disconnected that a discharge current does not flow into the current path of the power source 62. This makes it possible to perform only charge through the charging diode in the power source 62. It is to be noted that, for example, when a large current flows during discharge, the switch controller 67 may block the discharge current.

It is to be noted that the overcharge detection voltage of the secondary battery may be, for example, 4.20 V±0.05 V, and the overdischarge detection voltage may be, for example, 2.4 V±0.1 V.

The memory 68 may be, for example, an EEPROM that is a non-volatile memory. The memory 68 may hold, for example, numerical values calculated by the controller 61 and information of the secondary battery measured in a manufacturing process (such as internal resistance in an initial state). It is to be noted that, in a case in which the memory 68 holds full charge capacity of the secondary battery, the controller 61 is allowed to comprehend information such as remaining capacity.

The temperature detecting element 69 measures a temperature of the power source 62, and outputs a result of the measurement to the controller 61. The temperature detecting element 69 may be, for example, a thermistor.

The cathode terminal 71 and the anode terminal 72 are terminals that may be coupled to, for example, an external device (such as a notebook personal computer) driven with use of the battery pack or an external device (such as a battery charger) used for charge of the battery pack. The power source 62 is charged and discharged via the cathode terminal 71 and the anode terminal 72.

<2-3. Electric Vehicle>

FIG. 11 illustrates a block configuration of a hybrid automobile that is an example of an electric vehicle. The electric vehicle may include, for example, a controller 74, an engine 75, a power source 76, a driving motor 77, a differential 78, an electric generator 79, a transmission 80, a clutch 81, inverters 82 and 83, and various sensors 84 inside a housing 73 made of metal. Other than the components mentioned above, the electric vehicle may include, for example, a front drive shaft 85 and a front tire 86 that are coupled to the differential 78 and the transmission 80, and a rear drive shaft 87, and a rear tire 88.

The electric vehicle may be runnable with use of one of the engine 75 and the motor 77 as a drive source, for example. The engine 75 is a main power source, and may be, for example, a petrol engine. In a case in which the engine 75 is used as the power source, drive power (torque) of the engine 75 may be transferred to the front tire 86 or the rear tire 88 via the differential 78, the transmission 80, and the clutch 81 that are drive sections, for example. It is to be noted that the torque of the engine 75 may be also transferred to the electric generator 79. With use of the torque, the electric generator 79 generates alternating-current electric power. The generated alternating-current electric power is converted into direct-current electric power via the inverter 83, and the converted electric power is accumulated in the power source 76. In a case in which the motor 77 that is a conversion section is used as the power source, electric power (direct-current electric power) supplied from the power source 76 is converted into alternating-current electric power via the inverter 82, and the motor 77 is driven with use of the alternating-current electric power. Drive power (torque) obtained by converting the electric power by the motor 77 may be transferred to the front tire 86 or the rear tire 8 via the differential 78, the transmission 80, and the clutch 81 that are the drive sections, for example.

It is to be noted that, when speed of the electric vehicle is decreased by an unillustrated brake mechanism, resistance at the time of speed reduction may be transferred to the motor 77 as torque, and the motor 77 may generate alternating-current electric power by utilizing the torque. It may be preferable that this alternating-current electric power be converted into direct-current electric power via the inverter 82, and the direct-current regenerative electric power be accumulated in the power source 76.

The controller 74 controls an operation of the entire electric vehicle, and may include, for example, a CPU. The power source 76 includes one or more secondary batteries. The power source 76 may be coupled to an external power source, and the power source 76 may be allowed to accumulate electric power by receiving electric power supply from the external power source. The various sensors 84 may be used, for example, for control of the number of revolutions of the engine 75 and for control of an opening level (a throttle opening level) of an unillustrated throttle valve. The various sensors 84 may include, for example, a speed sensor, an acceleration sensor, and an engine frequency sensor.

It is to be noted that, although the description has been given of the case in which the electric vehicle is the hybrid automobile, the electric vehicle may be a vehicle (an electric automobile) that operates with use of only the power source 76 and the motor 77 and without using the engine 75.

<2-4. Electric Power Storage System>

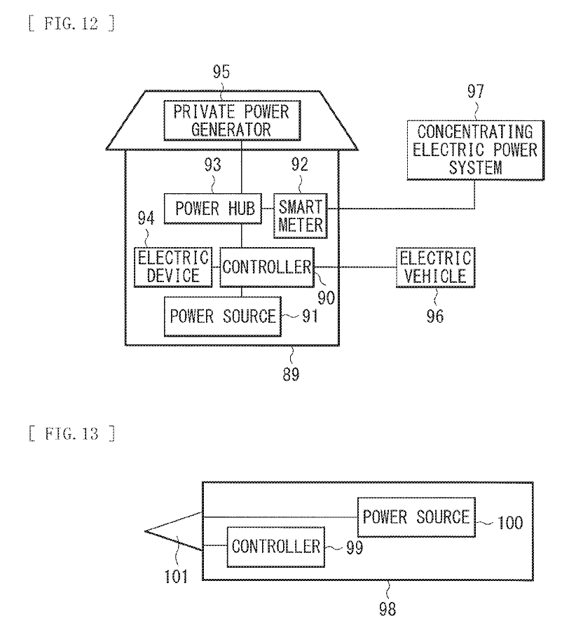

FIG. 12 illustrates a block configuration of an electric power storage system. The electric power storage system may include, for example, a controller 90, a power source 91, a smart meter 92, and a power hub 93, inside a house 89 such as a general residence or a commercial building.

In this example, the power source 91 may be coupled to an electric device 94 provided inside the house 89 and may be allowed to be coupled to an electric vehicle 96 parked outside the house 89, for example. Further, for example, the power source 91 may be coupled to a private power generator 95 provided in the house 89 via the power hub 93, and may be allowed to be coupled to an outside concentrating electric power system 97 via the smart meter 92 and the power hub 93.

It is to be noted that the electric device 94 may include, for example, one or more home electric products. Non-limiting examples of the home electric products may include a refrigerator, an air conditioner, a television, and a water heater. The private power generator 95 may include, for example, one or more of a solar power generator, a wind power generator, and other power generators. The electric vehicle 96 may include, for example, one or more of an electric automobile, an electric motorcycle, a hybrid automobile, and other electric vehicles. The concentrating electric power system 97 may include, for example, one or more of a thermal power plant, an atomic power plant, a hydraulic power plant, a wind power plant, and other power plants.

The controller 90 controls an operation of the entire electric power storage system (including a used state of the power source 91), and may include, for example, a CPU. The power source 91 includes one or more secondary batteries. The smart meter 92 may be an electric power meter that is compatible with a network and is provided in the house 89 demanding electric power, and may be communicable with an electric power supplier, for example. Accordingly, for example, while the smart meter 92 communicates with outside, the smart meter 92 controls balance between supply and demand in the house 89, which allows for effective and stable energy supply.

In the electric power storage system, for example, electric power may be accumulated in the power source 91 from the concentrating electric power system 97, that is an external power source, via the smart meter 92 and the power hub 93, and electric power may be accumulated in the power source 91 from the private power generator 95, that is an independent power source, via the power hub 93. The electric power accumulated in the power source 91 is supplied to the electric device 94 and the electric vehicle 96 in accordance with an instruction from the controller 90. This allows the electric device 94 to be operable, and allows the electric vehicle 96 to be chargeable. In other words, the electric power storage system is a system that makes it possible to accumulate and supply electric power in the house 89 with use of the power source 91.

The electric power accumulated in the power source 91 is allowed to be utilized optionally. Hence, for example, electric power may be accumulated in the power source 91 from the concentrating electric power system 97 in the middle of night when an electric rate is inexpensive, and the electric power accumulated in the power source 91 may be used during daytime hours when the electric rate is expensive.

It is to be noted that the foregoing electric power storage system may be provided for each household (each family unit), or may be provided for a plurality of households (a plurality of family units).

<2-5. Electric Power Tool>

FIG. 13 illustrates a block configuration of an electric power tool. The electric power tool may be, for example, an electric drill, and may include a controller 99 and a power source 100 inside a tool body 98 made of a plastic material, for example. A drill section 101 that is a movable section may be attached to the tool body 98 in an operable (rotatable) manner, for example.

The controller 99 controls an operation of the entire electric power tool (including a used state of the power source 100), and may include, for example, a CPU. The power source 100 includes one or more secondary batteries. The controller 99 allows electric power to be supplied from the power source 100 to the drill section 101 in accordance with an operation by an unillustrated operation switch.

### EXAMPLES

Examples of the present technology will be described in detail.

### Experimental Examples 1-1 to 1-11

The laminated film type lithium-ion secondary batteries illustrated in FIGS. 4 to 7 were fabricated by the following procedure.

The cathode 33 was fabricated as follows. First, 96 parts by mass of a cathode active material (LiCoO₂), 3 parts by mass of a cathode binder (polyvinylidene fluoride), and 1 part by mass of a cathode conductor (carbon black) were mixed to obtain a cathode mixture. Subsequently, the cathode mixture was dispersed in an organic solvent (N-methyl-2-pyrrolidone) to obtain paste cathode mixture slurry. Subsequently, both surfaces of the cathode current collector 33A (a strip-shaped aluminum foil having a thickness of 20 μm) were coated with the cathode mixture slurry with use of a coating apparatus, and thereafter, the cathode mixture slurry was dried to form the cathode active material layer 33B. Lastly, the cathode active material layer 33B was compression-molded with use of a roll pressing machine.

The anode 34 was fabricated as follows. First, 90 parts by mass of an anode active material (graphite that is a carbon material) and 10 parts by mass of an anode binder (polyvinylidene fluoride) were mixed to obtain an anode mixture. Subsequently, the anode mixture was dispersed in an organic solvent (N-methyl-2-pyrrolidone) to obtain paste anode mixture slurry. Subsequently, both surfaces of the anode current collector 34A (a strip-shaped copper foil having a thickness of 15 μm) were coated with the anode mixture slurry, and thereafter, the anode mixture slurry was dried to form the anode active material layer 34B. Lastly, the anode active material layer 34B was compression-molded with use of a roll pressing machine.

The liquid electrolyte (electrolytic solution) was prepared as follows. An electrolyte salt was dissolved in a nonaqueous solvent, and thereafter, on as-necessary basis, the dissolved polymer compound was dissolved in the nonaqueous solvent. In this case, as the nonaqueous solvent, a mixed solvent of ethylene carbonate (EC) and propylene carbonate (PC) was used, and as the electrolyte salt, lithium hexafluorophosphate (LiPF₆) was used. Moreover, as illustrated in Table 1, as the dissolved polymer compound, polyvinylidene fluoride (PVDF), polyethylene oxide (PEO), polyacrylonitrile (PAN), and poly(methyl methacrylate ethylene oxide ester) (PMMA-EOE) represented by the formula (1) were used. The value of m in the formula (1) was m=1 in PMMA-EOE 1, m=4 in PMMA-EOE 4, and m=9 in PMMA-EOE 9. The composition of the nonaqueous solvent was EC:PC=50:50 in weight ratio, and a content of the electrolyte salt was 1 mol/kg with respect to the nonaqueous solvent. A content of the dissolved polymer compound in the electrolytic solution was 0.1 wt %. A weight-average molecular weight of the dissolved polymer compound was 600000.

The gel electrolyte (the electrolyte layer 36) was prepared as follows. The foregoing electrolytic solution, the non-dissolved polymer compound, and an organic solvent for viscosity adjustment (dimethyl carbonate) were mixed to prepare a precursor solution. In this case, as the non-dissolved polymer compound, polyvinylidene fluoride (PVDF) was used as illustrated in Table 1. A weight ratio of the electrolytic solution to the non-dissolved polymer compound was 3:1. Subsequently, each of the cathode 33 and the anode 34 was coated with the precursor solution, and thereafter, the precursor solution was dried.

As can be seen from Table 1, one of the electrolytic solution and the electrolyte layer 36 was used. More specifically, in a case in which the non-dissolved polymer compound was not used, the electrolytic solution was used as it is. In contrast, in a case in which the non-dissolved polymer compound was used, the electrolytic solution was held by the non-dissolved polymer compound; therefore, the electrolyte layer 36 was used.

The secondary battery was assembled as follows. First, the cathode lead 31 made of aluminum was attached to the cathode current collector 33A of the cathode 33 by welding, and the anode lead 32 made of copper was attached to the anode current collector 34A of the anode 34 by welding. Subsequently, the cathode 33 and the anode 34 were stacked with the separator 35 (a microporous polypropylene film having a thickness of 23 μm) in between, and the cathode 33, the anode 34, and the separator 35 were spirally wound in a longitudinal direction to fabricate the spirally wound electrode body 30. Thereafter, the protective tape 37 was attached onto the outermost periphery of the spirally wound electrode body 30. Subsequently, the outer package member 40 was folded to interpose the spirally wound electrode body 30, and thereafter, the outer edges on three sides of the outer package member 40 were thermally fusion-bonded. Thus, the spirally wound electrode body 30 was contained inside a pouch formed of the outer package member 40. The outer package member 40 used here was a moisture-resistant aluminum laminated film (having a total thickness of 100 μm) in which a nylon film (having a thickness of 30 μm), an aluminum foil (having a thickness of 40 μm), and a cast polypropylene film (having a thickness of 30 μm) were laminated from outside. Lastly, the electrolytic solution was injected inside the outer package member 40, and the spirally wound electrode body 30 was impregnated with the electrolytic solution. Thereafter, outer edges on the remaining one side of the outer package member 40 were thermally fusion-bonded in a reduced-pressure environment. In this case, the adhesive film 41 (an acid-modified propylene film having a thickness of 50 μm) was inserted between cathode lead 31 and the outer package member 40, and the adhesive film 41 was inserted between the anode lead 32 and the outer package member 40 in a similar manner.

Upon assembling the secondary battery with use of the electrolyte layer 36, a similar procedure to that in a case in which the foregoing electrolytic solution was used was performed, except that the cathode 33 on which the electrolyte layer 36 was formed and the anode 34 on which the electrolyte layer 36 was formed were used, and the electrolytic solution was not injected inside the outer package member 40.

It is to be noted that, when the secondary battery was assembled, the separator 35 on which the polymer compound layers 36 and 37 were formed was used on as-necessary basis. Upon forming the polymer compound layer 36, the fluorine-containing polymer compound was dissolved in an organic solvent (N-methyl-2-pyrrolidone) to prepare a process solution. As the fluorine-containing polymer compound, polyvinylidene fluoride (PVDF) was used as illustrated in Table 1. Subsequently, the cathode-facing surface 35X of the separator 35 was coated with the process solution, and thereafter, the process solution was dried to form the polymer compound layer 36. Upon forming the polymer compound layer 37, a similar procedure to that in the case in which the polymer compound layer 36 was formed was performed, except that the anode-facing surface 35Y of the separator 35 was coated with the process solution.

Thus, the laminated film type secondary batteries were completed. When the secondary battery was fabricated, the thickness of the cathode active material layer 33B was so adjusted as to cause the charge-discharge capacity of the anode 34 to be larger than charge-discharge capacity of the cathode 33, thereby prevent lithium metal from being precipitated on the anode 34 in a completely-charged state.

When cycle characteristics and swollenness characteristics were examined as battery characteristics of each of the secondary batteries.

The cycle characteristics were examined as follows. First, the secondary battery was kept in a high temperature environment (at 60° C. for two weeks). Subsequently, one cycle of charge and discharge was performed on the secondary battery in a high temperature environment (at 45° C.) to measure discharge capacity at the first cycle. Subsequently, the secondary battery was repeatedly charged and discharged until the total number of cycles reached 500 cycles in the same environment to measure discharge capacity at the 500th cycle. A cycle retention ratio (%)=(discharge capacity at the 500th cycle/discharge capacity at the first cycle)×100 was calculated from these results. When the secondary battery was charged, charge was performed at a current of 0.2 C until the voltage reached 4.2 V, and thereafter, charge was further performed at the voltage of 4.2 V until the current reached 0.05 C. When the secondary battery was discharged, discharge was performed at a current of 0.2 C until the voltage reached 2.5 V. It is to be noted that “0.2 C” refers to a current value at which the battery capacity (theoretical capacity) is completely discharged in 5 hours, and “0.05 C” refers to a current value at which the battery capacity is completely discharged in 20 hours.

The swollenness characteristics were examined as follows. In the foregoing procedure of examining the cycle characteristics, a thickness (mm) of the secondary battery was measured before repeating charge and discharge, and thereafter, the thickness (mm) of the secondary battery was measured after the charge and discharge were repeated. A thickness change rate (%)=(thickness after repeating charge and discharge/thickness before repeating charge and discharge)×100 was calculated from these results.

TABLE 1
Battery Structure: Laminated Film Type

| | Electrolytic Solution or | | | | |
|---|---|---|---|---|---|
| | Electrolyte Layer | | Separator | | Thick- |
| | Dissolved | Non- | Fluorine- | Capacity | ness |
| Experi- | Polymer | dissolved | containing | Retention | Change |
| mental | Com- | Polymer | Polymer | Ratio | Rate |
| Example | pound | Compound | Compound | (%) | (%) |
| 1-1 | PVDF | — | — | 80 | +19 |
| 1-2 | PVDF | PVDF | — | 95 | +5 |
| 1-3 | PEO | PVDF | — | 91 | +9 |
| 1-4 | PAN | PVDF | — | 92 | +9 |
| 1-5 | PMMA- | PVDF | — | 92 | +10 |
| | EOE 1 | | | | |
| 1-6 | PMMA- | PVDF | — | 90 | +11 |
| | EOE 4 | | | | |
| 1-7 | PMMA- | PVDF | — | 90 | +10 |
| | EOE 9 | | | | |
| 1-8 | PVDF | — | PVDF | 94 | +6 |
| 1-9 | — | — | — | 72 | +25 |
| 1-10 | — | PVDF | — | 75 | +24 |
| 1-11 | — | — | PVDF | 73 | +30 |

The capacity retention ratio and the thickness change rate varied depending on the presence or absence of the dissolved polymer compound in the electrolytic solution.

More specifically, in a case in which the electrolytic solution contained the dissolved polymer compound (Experimental Examples 1-1 to 1-8), the capacity retention ratio largely increased, and the thickness change rate largely decreased, as compared with a case in which the electrolytic solution did not contain the dissolved polymer compound (Experimental Examples 1-9 to 1-11).

In particular, in the case in which the electrolytic solution contained the dissolved polymer compound, the following tendencies were achieved.

Firstly, the foregoing advantageous tendency, namely, a tendency that when the electrolytic solution contained the dissolved polymer compound, the capacity retention ratio increased and the thickness change rate decreased was achieved independently of the kind of the dissolved polymer compound.

Secondly, when the electrolytic solution was held by the non-dissolved polymer compound (Experimental Example 1-2), the capacity retention ratio further increased, and the thickness change rate further decreased, as compared with a case in which the electrolytic solution was not held by the non-dissolved polymer compound (Experimental Example 1-1).

Thirdly, when the polymer compound layers 36 and 37 were formed on the separator 35 (Experimental Example 1-8), the capacity retention ratio further increased, and the thickness change rate further decreased, as compared with a case in which the polymer compound layers 36 and 37 were not formed on the separator 35 (Experimental Example 1-1).

### Experimental Examples 2-1 and 2-2

The secondary batteries were fabricated by a similar procedure to the procedure in Experimental Examples 1-1 to 1-11, except that the cylindrical type secondary batteries illustrated in FIGS. 1 to 3 were fabricated in place of the laminated film type secondary batteries, and the battery characteristics of the secondary batteries were examined.

First, the cathode 21 in which the cathode active material layer 21B was provided on the cathode current collector 21A was fabricated, and the anode 22 in which the anode active material layer 22B was provided on the anode current collector 22A was fabricated by a similar procedure to that in the case in which the laminated film type secondary battery was fabricated. Subsequently, the cathode 21 and the anode 22 were stacked with the separator 23 on which the polymer compound layers 24 and 25 were formed in between, and thereafter, and the cathode 21, the anode 22, and the separator 23 were spirally wound in a longitudinal direction to form the spirally wound electrode body 20. Subsequently, the spirally wound electrode body 20 was sandwiched between the pair of insulating plates 12 and 13, and was contained inside the battery can 11. In this case, the end tip of the cathode lead 25 was attached to the safety valve mechanism 15 by welding, and the end tip of the anode lead 26 was attached to the battery can 11 by welding. Subsequently, the electrolytic solution was injected inside the battery can 11, and the spirally wound electrode body 20 was impregnated with the electrolytic solution. Lastly, the battery cover 14, the safety valve mechanism 15, and the PTC device 16 were swaged with the gasket 17 at the open end of the battery can 11. Thus, the cylindrical type secondary battery was completed.

TABLE 2
Battery Structure: Cylindrical Type

| | Electrolytic Solution or | | | | |
|---|---|---|---|---|---|
| | Electrolyte Layer | | | Separator | Thick- |
| | Dissolved | Non- | Fluorine- | Capacity | ness |
| Experi- | Polymer | dissolved | containing | Retention | Change |
| mental | Com- | Polymer | Polymer | Ratio | Rate |
| Example | pound | Compound | Compound | (%) | (%) |
| 2-1 | PVDF | — | PVDF | 94 | +7 |
| 2-2 | — | — | PVDF | 93 | +8 |

Even in the cylindrical type secondary batteries (Table 2), similar results to those in the foregoing laminated film type secondary batteries (Table 1) were achieved. More specifically, in the case in which the electrolytic solution contained the dissolved polymer compound (Experimental Example 2-1), the capacity retention ratio largely increased, and the thickness change rage largely decreased, as compared with the case in which the electrolytic solution did not contain the dissolved polymer compound (Experimental Example 2-2).

In this case, in the cylindrical type secondary batteries (Table 2), a difference in the thickness change rate between the presence and absence of the dissolved polymer compound (Experimental Examples 2-1 and 2-2) was only 7%−8%=−1%. In contrast, in the laminated film type secondary batteries (Table 1), a difference in the thickness change rate between the presence and absence of the dissolved polymer compound (Experimental Examples 1-8 and 1-11) reached 6%−30%=−24%.

This result indicates the following tendency. The cylindrical type secondary battery that includes an outer package member (the battery can 11 made of metal) having rigidity is inherently resistant to swollenness. In contrast, the laminated film type secondary battery that includes an outer package member (the film-like outer package member 40) having flexibility is inherently easily swollen. Accordingly, an effect of suppressing swollenness of the secondary battery resulting from a function of suppressing decomposition of the electrolytic solution by the dissolved polymer compound is actually exhibited more remarkably in the laminated film type secondary battery than in the cylindrical type secondary battery.

### Experimental Example 3-1 to 3-11

As illustrated in Table 3, the laminated film type secondary batteries were fabricated by a similar procedure, except that the weight-average molecular weight of the dissolved polymer compound (PAN) was changed, and the cycle characteristics and the swollenness characteristics of the secondary batteries were examined.

TABLE 3
Battery Structure: Laminated Film Type

| | Electrolytic Solution or | | | | | |
|---|---|---|---|---|---|---|
| | Electrolyte Layer | | | | | |
| | Dissolved Polymer | | | | | |
| | Compound | | | Separator | | |
| | | Weight- | Non- | Fluorine- | Capacity | Thickness |
| | | Average | dissolved | containing | Retention | Change |
| Experimental | | Molecular | Polymer | Polymer | Ratio | Rate |
| Example | Kind | Weight | Compound | Compound | (%) | (%) |
| 3-1 | PAN | 500 | PVDF | — | 89 | +5 |
| 3-2 | PAN | 2000 | PVDF | — | 90 | +5 |
| 3-3 | PAN | 10000 | PVDF | — | 91 | +6 |
| 3-4 | PAN | 100000 | PVDF | — | 91 | +8 |
| 1-4 | PAN | 600000 | PVDF | — | 92 | +9 |
| 3-5 | PAN | 1000000 | PVDF | — | 92 | +10 |
| 3-6 | PAN | 500 | — | PVDF | 87 | +6 |
| 3-7 | PAN | 2000 | — | PVDF | 89 | +7 |
| 3-8 | PAN | 10000 | — | PVDF | 89 | +7 |
| 3-9 | PAN | 100000 | — | PVDF | 90 | +8 |
| 3-10 | PAN | 600000 | — | PVDF | 91 | +10 |
| 3-11 | PAN | 1000000 | — | PVDF | 91 | +11 |
| 1-9 | — | — | — | — | 72 | +25 |
| 1-10 | — | — | PVDF | — | 75 | +24 |
| 1-11 | — | — | — | PVDF | 73 | +30 |

Even though the weight-average molecular weight of the dissolved polymer compound (PAN) was changed, similar results to those in Table. 1 were achieved independently of the weight-average molecular weight. More specifically, in the case in which the electrolytic solution contained the dissolved polymer compound (Experimental Examples 3-1 to 3-11), a larger capacity retention ratio and a smaller thickness change rate were achieved, as compared with the case in which the electrolytic solution did not contain the dissolved polymer compound (Experimental Examples 1-9 to 1-11).

### Experimental Example 4-1 to 4-12

As illustrated in Table 4, the laminated film type secondary batteries were fabricated by a similar procedure, except that the composition of the nonaqueous solvent was changed, and the cycle characteristics and the swollenness characteristics of the secondary batteries were examined. In this case, as the nonaqueous solvent, in place of PC, ethylmethyl carbonate (EMC), diethyl carbonate (DEC), methyl propyl carbonate (MPC), and propyl propionate (PP) were used.

TABLE 4
Battery Structure: Laminated Film Type

| | Electrolytic Solution or Electrolyte Layer | | | Separator | | |
|---|---|---|---|---|---|---|
| | | Non- | | Fluorine- | Capacity | Thickness |
| | Dissolved | dissolved | | containing | Retention | Change |
| Experimental | Polymer | Polymer | Nonaqueous | Polymer | Ratio | Rate |
| Example | Compound | Compound | Solvent | Compound | (%) | (%) |
| 1-2 | PVDF | PVDF | EC + PC | — | 95 | +5 |
| 4-1 | PVDF | PVDF | EC + EMC | — | 96 | +11 |
| 4-2 | PVDF | PVDF | EC + DEC | — | 95 | +8 |
| 4-3 | PVDF | PVDF | EC + MPC | — | 94 | +9 |
| 4-4 | PVDF | PVDF | EC + PP | — | 94 | +10 |
| 1-8 | PVDF | — | EC + PC | PVDF | 94 | +6 |
| 4-5 | PVDF | — | EC + EMC | PVDF | 95 | +14 |
| 4-6 | PVDF | — | EC + DEC | PVDF | 93 | +10 |
| 4-7 | PVDF | — | EC + MPC | PVDF | 93 | +12 |
| 4-8 | PVDF | — | EC + PP | PVDF | 92 | +12 |
| 1-9 | — | — | EC + PC | — | 72 | +25 |
| 1-10 | — | PVDF | EC + PC | — | 75 | +24 |
| 4-9 | — | PVDF | EC + EMC | — | 77 | +32 |
| 4-10 | — | PVDF | EC + DEC | — | 75 | +27 |
| 4-11 | — | PVDF | EC + MPC | — | 75 | +28 |
| 4-12 | — | PVDF | EC + PP | — | 74 | +28 |
| 1-11 | — | — | EC + PC | PVDF | 73 | +30 |

Even though the composition of the nonaqueous solvent was changed, similar results to those in Table. 1 were achieved independently of the composition. More specifically, in the case in which the electrolytic solution contained the dissolved polymer compound (Experimental Examples 4-1 to 4-8), a larger capacity retention ration and a smaller thickness change rate were achieved, as compared with the case in which the electrolytic solution did not contain the dissolved polymer compound (Experimental Examples 1-9 to 1-11 and 4-9 to 4-12).

### Experimental Examples 5-1 to 5-18

As illustrated in Table 5, the laminated film type secondary batteries were fabricated by a similar procedure, except that an additive was added to the electrolytic solution to change the composition of the electrolytic solution, and the cycle characteristics and the swollenness characteristics of the secondary batteries were examined. In this case, as other nonaqueous solvents, vinylene carbonate (VC) that was an unsaturated cyclic carbonate ester, 4-fluoro-1,3-dioxolane-2-one (FEC) that was a halogenated carbonate ester, 1,3-propane sultone (PS) that was a sulfonate ester, succinonitrile (SN) and adiponitrile (AP) that were dicyano compounds were used. As other electrolytic salt, the compound (LiBOB) represented by the formula (3-6) was used. Contents (wt %) of the respective additives in the electrolytic solution are as illustrated in Table 5.

TABLE 5
Battery Structure: Laminated Film Type

| | Electrolytic Solution or Electrolyte Layer | | | | Separator | | |
|---|---|---|---|---|---|---|---|
| | | Non- | | | Fluorine- | Capacity | Thickness |
| | Dissolved | dissolved | Additive | | containing | Retention | Change |
| Experimental | Polymer | Polymer | | Content | Polymer | Ratio | Rate |
| Example | Compound | Compound | Kind | (wt %) | Compound | (%) | (%) |
| 1-2 | PVDF | PVDF | — | — | — | 95 | +5 |
| 5-1 | PVDF | PVDF | VC | 1 | — | 96 | +4 |
| 5-2 | PVDF | PVDF | FEC | 1 | — | 96 | +4 |
| 5-3 | PVDF | PVDF | PS | 1 | — | 96 | +3 |
| 5-4 | PVDF | PVDF | SN | 1 | — | 94 | +2 |
| 5-5 | PVDF | PVDF | AN | 1 | — | 94 | +2 |
| 5-6 | PVDF | PVDF | LiBOB | 0.1 | — | 96 | +6 |
| 1-8 | PVDF | — | — | — | PVDF | 94 | +6 |
| 5-7 | PVDF | — | VC | 1 | PVDF | 95 | +4 |
| 5-8 | PVDF | — | FEC | 1 | PVDF | 95 | +5 |
| 5-9 | PVDF | — | PS | 1 | PVDF | 96 | +4 |
| 5-10 | PVDF | — | SN | 1 | PVDF | 92 | +3 |
| 5-11 | PVDF | — | AN | 1 | PVDF | 93 | +4 |
| 5-12 | PVDF | — | LiBOB | 0.1 | PVDF | 96 | +6 |
| 1-9 | — | — | — | — | — | 72 | +25 |
| 1-10 | — | PVDF | — | — | — | 75 | +24 |
| 5-13 | — | PVDF | VC | 1 | — | 78 | +21 |
| 5-14 | — | PVDF | FEC | 1 | — | 77 | +22 |
| 5-15 | — | PVDF | PS | 1 | — | 79 | +20 |
| 5-16 | — | PVDF | SN | 1 | — | 74 | +19 |
| 5-17 | — | PVDF | AN | 1 | — | 74 | +20 |
| 5-18 | — | PVDF | LiBOB | 0.1 | — | 78 | +25 |
| 1-11 | — | — | — | — | PVDF | 73 | +30 |

Even though the composition of the electrolytic solution was changed, similar results to those in Table. 1 were achieved independently of the composition. More specifically, in the case in which the electrolytic solution contained the dissolved polymer compound (Experimental Examples 5-1 to 5-12), a larger capacity retention ratio and a smaller thickness change rate were achieved, as compared with the case in which the electrolytic solution did not contain the dissolved polymer compound (Experimental Examples 1-9 to 1-11 and 5-13 to 5-18).

As can be seen from the results illustrated in Tables 1 to 5, when the polymer compound was dissolved in the electrolytic solution, the cycle characteristics and swollenness characteristics were improved. Accordingly, the secondary battery achieved superior battery characteristics.

Although the present technology has been described above referring to some embodiments and examples, the present technology is not limited thereto, and may be variously modified. For example, the description has been given with reference to examples in which the battery structure is of the cylindrical type and the laminated film type, and the battery element has the spirally wound structure. However, the battery structure and the battery element structure are not limited thereto. The secondary battery of the present technology is similarly applicable also to a case in which other battery structure such as that of a square type, a coin type or a button type is employed. Moreover, the secondary battery of the present technology is similarly applicable also to a case in which the battery element has other structure such as a stacked structure.

Moreover, a secondary battery-use electrolytic solution of the present technology may be applicable not only to secondary batteries but also to other electrochemical devices. Non-limiting examples of other electrochemical devices may include a capacitor. Note that the effects described in the present specification are illustrative and non-limiting. The technology may have effects other than those described in the present specification.

It is to be noted that the present technology may have the following configurations.

(1)

A secondary battery, including:

a cathode;

an anode; and

an electrolytic solution in which a polymer compound is dissolved.

(2)

The secondary battery according to (1), wherein

the electrolytic solution contains a nonaqueous solvent and an electrolyte salt, and

the polymer compound is dissolved by the nonaqueous solvent.

(3)
The secondary battery according to (1) or (2), wherein the polymer compound contains one or more of polyvinylidene fluoride, polyethylene oxide, polyacrylonitrile, and poly(methyl methacrylate) ethylene oxide ester represented by a formula (1):

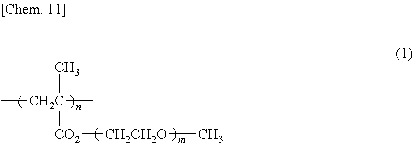

where n is an integer of 1 or more, and m is 1, 4, or 9.

(4)
The secondary battery according to any one of (1) to (3), further including a polymer compound that is not dissolved in the electrolytic solution, wherein

the electrolytic solution is held by the polymer compound that is not dissolved in the electrolytic solution.

(5)

The secondary battery according to any one of (1) to (4), further including:

a separator provided between the cathode and the anode; and

a polymer compound layer provided between the cathode and the separator, between the anode and the separator, or both.

(6)

The secondary battery according to (5), wherein

the polymer compound layer contains a fluorine-containing polymer compound, and

the fluorine-containing polymer compound contains one or more fluorines (F) as a constituent element.

(7)

The secondary battery according to (5) or (6), wherein

the separator has a cathode-facing surface that faces the cathode and an anode-facing surface that faces the anode, and

the polymer compound layer is provided one or both of the cathode-facing surface and the anode-facing surface.

(8)

The secondary battery according to any one of (1) to (7), wherein the cathode, the anode, and the electrolytic solution are contained inside a film-like outer package member.

(9)

The secondary battery according to any one of (1) to (8), wherein the secondary battery is a lithium secondary battery.

(10)

A secondary battery-use electrolytic solution including a polymer compound that is dissolved in the secondary battery-use electrolytic solution.

(11)

A battery pack including:

the secondary battery according to any one of (1) to (9);

a controller that controls an operation of the secondary battery; and

a switch section that switches the operation of the secondary battery in accordance with an instruction from the controller.

(12)

An electric vehicle including:

the secondary battery according to any one of (1) to (9);

a converter that converts electric power supplied from the secondary battery into drive power;

a drive section that operates in accordance with the drive power; and

a controller that controls an operation of the secondary battery.

(13)

An electric power storage system including:

the secondary battery according to any one of (1) to (9);

one or more electric devices that are supplied with electric power from the secondary battery; and

a controller that controls the supplying of the electric power from the secondary battery to the one or more electric devices.

(14)

An electric power tool including:

the secondary battery according to any one of (1) to (9); and

a movable section that is supplied with electric power from the secondary battery.

(15)

An electronic apparatus including the secondary battery according to any one of (1) to (9) as an electric power supply source.

This application claims the priority on the basis of Japanese Patent Application No. 2014-116975 filed on Jun. 5, 2014 and Japanese Patent Application No. 2014-194769 filed on Sep. 25, 2014 with Japan Patent Office, the entire contents of which are incorporated in this application by reference.

It should be understood by those skilled in the art that various modifications, combinations, sub-combinations, and alterations may occur depending on design requirements and other factors insofar as they are within the scope of the appended claims or the equivalents thereof.

1. A secondary battery, comprising:
a cathode;
an anode; and
an electrolytic solution in which a polymer compound is dissolved.

2. The secondary battery according to claim 1, wherein
the electrolytic solution contains a nonaqueous solvent and an electrolyte salt, and
the polymer compound is dissolved by the nonaqueous solvent.

3. The secondary battery according to claim 1, wherein the polymer compound contains one or more of polyvinylidene fluoride, polyethylene oxide, polyacrylonitrile, and poly(methyl methacrylate) ethylene oxide ester represented by a formula (1): 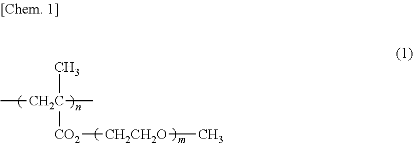
where n is an integer of 1 or more, and m is 1, 4, or 9.

4. The secondary battery according to claim 1, further comprising a polymer compound that is not dissolved in the electrolytic solution, wherein
the electrolytic solution is held by the polymer compound that is not dissolved in the electrolytic solution.

5. The secondary battery according to claim 1, further comprising:
a separator provided between the cathode and the anode; and
a polymer compound layer provided between the cathode and the separator, between the anode and the separator, or both.

6. The secondary battery according to claim 5, wherein
the polymer compound layer contains a fluorine-containing polymer compound, and
the fluorine-containing polymer compound contains one or more fluorines (F) as a constituent element.

7. The secondary battery according to claim 5, wherein
the separator has a cathode-facing surface that faces the cathode and an anode-facing surface that faces the anode, and
the polymer compound layer is provided one or both of the cathode-facing surface and the anode-facing surface.

8. The secondary battery according to claim 1, wherein the cathode, the anode, and the electrolytic solution are contained inside a film-like outer package member.

9. The secondary battery according to claim 1, wherein the secondary battery is a lithium secondary battery.

10. A secondary battery-use electrolytic solution comprising a polymer compound that is dissolved in the secondary battery-use electrolytic solution.

11. A battery pack comprising:
a secondary battery;
a controller that controls an operation of the secondary battery; and
a switch section that switches the operation of the secondary battery in accordance with an instruction from the controller,
the secondary battery including a cathode, an anode, and an electrolytic solution in which a polymer compound is dissolved.

12. An electric vehicle comprising:
a secondary battery;
a converter that converts electric power supplied from the secondary battery into drive power;
a drive section that operates in accordance with the drive power; and
a controller that controls an operation of the secondary battery,
the secondary battery including a cathode, an anode, and an electrolytic solution in which a polymer compound is dissolved.

13. An electric power storage system comprising:
a secondary battery;
one or more electric devices that are supplied with electric power from the secondary battery; and
a controller that controls the supplying of the electric power from the secondary battery to the one or more electric devices,
the secondary battery including a cathode, an anode, and an electrolytic solution in which a polymer compound is dissolved.

14. An electric power tool comprising:
a secondary battery; and
a movable section that is supplied with electric power from the secondary battery,
the secondary battery including a cathode, an anode, and an electrolytic solution in which a polymer compound is dissolved.

15. An electronic apparatus comprising a secondary battery as an electric power supply source, the secondary battery including a cathode, an anode, and an
electrolytic solution in which a polymer compound is dissolved.
